(19) United States
(12) Patent Application Publication
(10) Pub. No.: US 2007/0058055 A1
(43) Pub. Date: Mar. 15, 2007

(54) Solid-state imaging device, manufacturing method for solid-state imaging device, and camera using the same

(76) Inventors: Takumi Yamaguchi, Kyoto-shi (JP); Shigetaka Kasuga, Hirakata-shi (JP); Takahiko Murata, Osaka-shi (JP); Kenji Orita, Osaka-shi (JP)

Correspondence Address: MCDERMOTT WILL & EMERY LLP, 600 13TH STREET, NW, WASHINGTON, DC, 20005-3096, US

(21) Appl. No.: 10/566,671

(22) PCT Filed: Aug. 2, 2004
(86) PCT No.: PCT/JP04/11400

§ 371 Date: Oct. 10, 2006

(30) Foreign Application Priority Data
Aug. 1, 2003 (JP) 2003-285254
Jan. 15, 2004 (JP) 2004-008419
Jun. 28, 2004 (JP) 2004-189191

(51) Int. Cl. H04N 9/04

(52) U.S. Cl. 348/272

(57) ABSTRACT

A solid-state imaging device includes a plurality of light-receiving units two-dimensionally arrayed in a semiconductor substrate, a filter unit operable to transmit incident lights of selected wavelengths to the plurality of light receiving units and a light shielding unit operable to shield incident light, the light shielding unit having a plurality of apertures, each aperture opposing a corresponding light receiving unit. Here, on a path of incident light from the light shielding unit to the plurality of light shielding units, the filter unit is disposed between the light shielding unit and the plurality of light-receiving units. The solid-state imaging device prevents color mixing caused by oblique light.

### TECHNICAL FIELD

The present invention relates to a solid-state imaging device, a manufacturing method for a solid-state imaging device, and a camera using the same, and in particular to a technique for achieving a color solid-state imaging device of improved performance and smaller size.

### BACKGROUND ART

In solid-state imaging devices, light receiving elements corresponding to red (R), green (G), and blue (B) are arranged, for example, in a Bayer array. FIG. 1 is a schematic cross-sectional view illustrating a construction of a conventional solid-state imaging device. As shown in FIG.1, a solid-state imaging device 1 includes an N-type semi-conductor layer 101, a P-type semiconductor layer 102, light receiving elements 103R, 103G, 103B, an insulation layer 104, light shielding films 105, color filter 106R, 106G, and 106B, and collective lenses 107.

The P-type semiconductor layer 102 is formed on the N-type semiconductor layer 101. The light-receiving elements 103R, 103G, and 103B are buried in the P-type semiconductor layer 102, so as to be in contact with the insulation layer 104. Here, the light-receiving elements 103R, 103G, and 103B are separated from one another, with separation parts of the P-type semiconductor layer 102 therebetween. The light shielding films 105 are buried in the insulation layer 104, so as to be positioned above the separation parts of the P-type semiconductor layer 102.

The color filters 106R, 106G, and 106B are of the type that contains fine pigment particles, and have a thickness of approximately 1.5 μm to 2.0 μm. The pigment particles have a diameter of approximately 0.1 μm.

The color filter 106R is provided on the insulation layer 104 so as to oppose the light-receiving element 103R. Similarly, the color filter sections 106G and 106B are provided on the insulation layer 104 so as to oppose the light-receiving elements 103G and 103B respectively. One of the collective lenses 107 is provided on each of the color filter 106R, 106G, and 106B.

Of the light that has passed through the corresponding collective lens 107, the color filter 106G transmits only green light, and the green light is collected on the light-receiving element 103G. The light shielding films 105 prevent the green light, which has been transmitted through the color filter 106G, from entering the light-receiving elements 103R and 103B. Here, the light-receiving elements 103R, 103G, and 103B convert luminance of received light into an electric charge by photoelectric conversion, and store therein the electric charge.

Such a solid-state imaging device appears, for example, in Japanese Laid-open Patent Application No. H05-6986, and in “Kotaisatsuzousoshi no kiso” (The basics of solid-state imaging devices), Nihon Rikou Shuppannkai (Japan Science and Technology Publishing), by Andoh and Komobuchi, the Institute of Image, Information and Television Engineers, December 1999, p.183-188.

### DISCLOSURE OF THE INVENTION

With light entering a solid-state imaging device from various directions, there is a risk of the light that enters obliquely (hereinafter oblique light) being received by a light-receiving element other than the intended light-receiving element, thereby degrading color separation, decreasing resolution and wavelength sensitivity, and increasing noise.

Moreover, in order to increase the resolution of a solid-state imaging device its pixels have to be reduced in size. However, there is a limit as to how far the size of the pigment particles can be reduced, beyond which a loss of sensitivity and color uniformity inevitably occurs.

In order to solve these problems the present invention is a solid-state imaging device including: a plurality of light-receiving units two-dimensionally arrayed in a semi conductor substrate; a filter unit operable to transmit incident light of selected wavelengths to the plurality of light receiving units; and a light shielding unit operable to shield incident light, the light shielding unit having a plurality of apertures, each aperture opposing a corresponding light receiving unit, wherein on a path of incident light from the light shielding unit to the plurality of light shielding units, the filter unit is disposed between the light shielding unit and the plurality of light-receiving units.

With this construction, oblique light can be shielded such that it does not enter the filter unit, and i to reduce color mixing can therefore be reduced.

Here, the solid-state imaging device may further include a condensing unit operable to condense incident light on the corresponding light-receiving unit disposed in each of the plurality of apertures in the shielding unit.

With this construction, the condenser unit concentrates light on the appropriate light-receiving unit, and color mixing can therefore be reduced.

Further, the filter unit maybe composed of an in organic material. According to this construction, the filter unit can be manufactured in a series of semi-conductor substrate manufacturing processes, and it is therefore possible to improve the yield of solid-state imaging devices and reduce manufacturing costs.

The filter unit may have a multilayer film structure. With this construction, the thickness of the filter unit can be reduced, contributing to a reduction in the overall size of the solid-state imaging device.

The filter unit may be composed of photonic crystal. Further, the present invention is a solid-state imaging device including: a plurality of light-receiving units two-dimensionally arrayed in a semiconductor substrate; and a filter unit operable to transmit light of selected wavelengths to the plurality of light receiving units, wherein the filter unit is composed of photonic crystal. According to this construction, the filter unit concentrates oblique light on the appropriate receiving unit, and it is therefore possible to prevent color mixing.

Further the present invention is a camera including the solid-state imaging device having a plurality of light-receiving units two-dimensionally arrayed in a semiconductor substrate; a filter unit operable to transmit incident light of selected wavelengths to the plurality of light receiving units; and a light shielding unit operable to shield incident light, the light shielding unit having a plurality of apertures, each aperture opposing a corresponding light receiving unit, wherein on a path of incident light from the light shielding unit to the plurality of light shielding units, the filter unit is disposed between the light shielding unit and the plurality of light-receiving units.

Further, the present invention is a camera including a solid-state imaging device having: a plurality of light-receiving units two-dimensionally arrayed in a semiconductor substrate; and a filter unit operable to transmit light of selected wavelengths to the plurality of light receiving units, wherein the filter unit is composed of photonic crystal. According to this construction, it is possible to provide a camera capable of preventing color mixing and of taking high quality images.

Further, the present invention is a solid-state imaging device including a filter unit operable to transmit incident light of selected wavelengths of order λ, wherein the filter unit is a dielectric multilayer film that includes two λ/4 multilayer films, and an insulation layer sandwiched between the λ/4 multilayer films, the insulation layer having a thickness other than λ/4.

Being formed using a dielectric multilayer film as described above, the filter unit can have a smaller thickness. This prevents oblique light from reaching a pixel adjacent to an intended pixel, thereby improving the color separation function. Note that, in this specification a λ/4 multilayer film means a film composed of multiple layers, each of which has a thickness of approximately λ/4.

Here, the dielectric multilayer film may include: the insulation layer having an optical thickness other than λ/4, the two λ/4 multilayer films, each including a first dielectric layer having an optical thickness of λ/4 and being made of a material having a different refractive index from a material of the insulation layer, a second dielectric layer having an optical thickness of λ/4 and being made of a material having a refractive index equal to the refractive index of the material of the insulation layer, the first dielectric layer being formed on a main surface of the insulation layer, the second dielectric layer being formed on a main surface, of the first dielectric layer, that faces away from the insulation layer.

Here, the optical thickness of the insulation layer may be set such that the filter unit transmits light of the selected wavelengths of order λ.

According to this construction, color separation can be realized using a filter unit whose thickness is substantially equivalent to the wavelength of incident light (approximately 500 nm). As a result, the filter unit can have a smaller thickness, which is effective in reducing the degradation of the color separation function caused by oblique light.

Here, in a portion of the dielectric multilayer film corresponding to a light receiving unit, the insulation layer may have one or more through holes or grooves which penetrate in a direction vertical to the main surface of the insulation layer and are filled with a same material as the material forming the first dielectric layer, the filter unit may transmit light of a wavelength determined according to a ratio between an area of the one or more through holes or grooves, and an area of the insulation layer excluding the one or more through holes or grooves, when the insulation layer is seen in plan view.

According to this construction, in the insulation layer, materials of differing refractive index are alternately disposed in a direction parallel to the main surfaces of the insulation layer. This alters an effective refractive index experienced by incident light, thereby enabling wavelength selection to be realized. In this way, color separation can be realized using a filter unit having a thickness substantially equivalent to the wavelength of the incident light (approximately 500 nm). As a result, the filter unit can have a smaller thickness, and significantly inhibit the degradation of the color separation function caused by oblique light. Furthermore, since there is no need to vary the thickness of the insulation layer, the manufacturing process can be simplified, and stable color separation characteristics realized.

Here, the solid-state imaging device may further include a plurality of light-receiving units two-dimensionally arrayed in a semiconductor substrate, wherein each portion of the insulation layer corresponding to a light-receiving unit has an inwardly inclined lateral surface.

According to this construction, the filter unit can concentrate incident light. This can further prevent degradation of color separation.

Here, solid-state imaging device of the present invention may further include a plurality of light-receiving units two-dimensionally arrayed in a semiconductor substrate, wherein a region of the insulation layer through which light incident on a corresponding light-receiving unit is to be transmitted has a plurality of sections, each having a different thickness.

By forming an insulation layer having two or more differing thickness within a single pixel in this way, it is possible to widen the passband for entering the corresponding light-receiving unit, and consequently, to improve wavelength sensitivity for each color.

Here, an absorbing member for absorbing light reflected by the dielectric multilayer film may be provided on the side of the dielectric multilayer film to which the light is reflected. Further the absorbing member may be a color filter containing pigments or dyes. This construction can reduce the occurrence of noise due to light reflected by the dielectric multilayer film.

Further, the present invention is a camera including the solid-state imaging device having the filter unit that is composed of a dielectric multilayer film and transmits incident light of selected wavelengths of order λ, wherein the filter unit is a dielectric multilayer film that includes two λ4 multilayer films, and an insulation layer sandwiched between the λ/4 multilayer films, the insulation layer having a thickness other than λ/4. With this construction the camera can offer the favorable property of reduced color mixing.

Further, the present invention is a manufacturing method for a solid-state imaging device including a filter unit that transmits incident light of selected wavelengths of order λ, the filter unit being formed by conducting the following steps: a first formation step of forming a first dielectric multilayer film on a semiconductor substrate, the first dielectric multilayer film consisting of a plurality λ/4 optical films; a second formation step of forming a first insulation layer on the first dielectric multilayer film; a first removal step of removing the first insulation layer except for a first region; a third formation step of forming a second insulation layer on the first dielectric multilayer film and the first region of the first insulation layer; a second removal step of removing a second region of the second insulation layer, the second region being positioned on the first dielectric multilayer film; and a fourth formation step of forming a second dielectric multilayer film on the second insulation layer and the first dielectric multilayer film, the second dielectric multilayer film consisting of a plurality of λ/4 optical films.

When manufacturing a solid-state imaging device having a filter that is formed using a dielectric multilayer film, it is essential to control the thickness of each layer of the filter at the level of nanometers, in order to attain ideal wavelength selection. By utilizing the above-described film formation process performed under optimal conditions, the thickness of each of the layers making up the dielectric multilayer film can be controlled on the wafer to within plus/minus 2% of a uniform thickness distribution.

Further the present invention is a manufacturing method of a solid-state imaging device including a filter unit that transmits incident light of selected wavelengths of order λ, the filter unit being formed by conducting the following steps: a first formation step of forming a first dielectric multilayer film on a semiconductor substrate, the first dielectric multilayer film consisting of a plurality λ/4 optical films; a second formation step of forming a first insulation layer on a first region of the first dielectric multilayer film by using a liftoff method; a third formation step of forming a second insulation layer on a second region of the first dielectric multilayer film by using the liftoff method, the second region being different from the first region; and a fourth formation step of forming a second dielectric multilayer film on the first insulation layer, the second insulation layer, and the first dielectric multilayer film, the second dielectric multilayer film consisting of a plurality of λ/4 optical films.

Using the liftoff method to form an insulation layer in the filter unit realizes the same effects of more favorably controlling the thickness of the insulation layer, and reducing variation in the thickness.

Further, the present invention is a manufacturing method of a solid-state imaging device including a filter unit that transmits incident light of selected wavelengths of order λ, the filter unit being formed by conducting the following steps: a first formation step of forming a first multilayer dielectric film on a semiconductor substrate, the first multilayer dielectric film consisting of a plurality λ/4 optical films; a second formation step of forming a first insulation layer on the first dielectric multilayer film; a first removal step of removing the first insulation layer except for a first region; a third formation step of forming a second insulation layer on the first insulation layer in a second region that is within the first region, and on a region of the first dielectric multilayer film where the first insulation layer is not formed, by using a liftoff method; and a fourth formation step of forming a second dielectric multilayer film on the first insulation layer, the second insulation layer, the second dielectric multilayer film consisting of a plurality of λ/4 optical films.

To form an insulation layer having three levels of thickness, three layer formation steps are generally required. According to the above manufacturing method, however, the combination of etching and liftoff methods enable an insulation layer having three levels of thickness to be obtained in only two layer formation steps. Thus, the filter formation process can be simplified. This shortens the turnaround time, and reduces the manufacturing cost.

Further, the present invention is a manufacturing method of a solid-state imaging device including a filter unit that transmits incident light of selected wavelengths of order λ, the filter unit being formed by conducting the following steps: a first formation step of forming a first multilayer dielectric film on a semiconductor substrate, the first multilayer dielectric film consisting of a plurality λ/4 optical films; a second formation step of forming a first insulation layer on the first dielectric multilayer film; a first removal step of removing the first insulation layer except for a first region; a third formation step of forming a second insulation layer on the first dielectric multilayer film and the first region of the first insulation layer, the second insulation layer being made of a different material from the first insulation layer; a second removal step of removing the second insulation layer, except for a portion in a second region on the first insulation layer; and a fourth formation step of forming a second dielectric multilayer film on the first insulation layer, the second insulation layer, and the first dielectric multilayer film, the second dielectric multilayer film consisting of a plurality of λ/4 optical films.

To form an insulation layer having three levels of thickness, three layer formation steps are generally required. According to the above manufacturing method, however, using an insulation layer composed of mutually differing materials and performing selective etching enable an insulation layer having three levels of thickness to be obtained in only two layer formation steps. Thus, the filter formation process can be simplified. This shortens the turnaround time, and reduces the manufacturing cost.

Further, the present invention is a manufacturing method of a solid-state imaging device including a plurality of light-receiving units two-dimensionally arrayed in a semiconductor substrate, and a filter unit that transmits incident light of selected wavelengths of order λ, the filter unit including two dielectric multilayer films, each consisting of a plurality of λ/4 optical films, and an insulation layer sandwiched between the two dielectric multilayer films, the manufacturing method including: a formation step of forming a resist in a middle of each of a plurality of insulation layer portions that oppose the plurality of light receiving units; and a shaping step of shaping the insulation layer portions by etching, to give each insulation layer portion at least one inclined lateral surface.

Here, in the formation step, the resist may be formed so as to have an inclined lateral surface. Moreover, in the formation step, the resist may be formed so as to have an inclined lateral surface, by varying an amount of exposure to light.

Here, the solid-state imaging device may further include a plurality of light-receiving units two-dimensionally arrayed in a semiconductor substrate; the filter unit transmitting light of differing wavelengths according to a corresponding light receiving unit, wherein(i) lack or presence of the insulation layer, (ii) one of the thickness and material of the insulation layer, or (iii) a combination of thickness and material of the insulation layer differ depending on the wavelength of light to be transmitted to the opposing light receiving unit. According to this construction, color separation can be realized by the multilayer dielectric film, the presence of, and where present, the material and thickness of the insulation layer in the multilayer film depending on the corresponding light receiving element.

Here, the solid-state imaging device may further include: a plurality of light-receiving units two-dimensionally arrayed in a semiconductor substrate; and the filter unit transmitting light of differing wavelengths according to a corresponding light receiving unit, wherein the two λ/4 multilayer films are symmetrically structured with respect to the insulation layer.

Further the present invention is a solid-state imaging device including a filter unit that transmits incident light of selected wavelengths of order λ, wherein the filter unit is a dielectric multilayer film that includes two types of dielectric layer, each type having a different refractive index, in the dielectric multilayer film, a dielectric layer furthest from the light-receiving unit has a lower of the two refractive indices. This construction can prevent light that enters the filter unit from being reflected, and thereby realize high-quality imaging.

Further, the present invention is a solid-state imaging device including a filter unit that transmits incident light of selected wavelengths of order λ, wherein a protective layer is provided on one of main surfaces of a dielectric multilayer film, or between any given pair of dielectric layers making up the dielectric multilayer film. Here, the protective layer may be composed of silicon nitride. With this construction, the reliability and moisture resistance of the solid-state imaging device can be improved.

Here, the solid state imaging device may further include: a plurality of light-receiving units two-dimensionally arrayed in a semiconductor substrate; a plurality of light-condensing units each operable to condense incident light; the filter unit having a plurality of portions, each portion transmitting light of a particular wavelength that depends on a corresponding light receiving unit, wherein a filter unit main surface that faces away from the plurality of light-receiving units is flat. According to this construction, the same distance can be achieved between each light-collecting unit and a corresponding light-receiving unit. Therefore, light-collecting units having the same focal length can be used for the solid-state imaging device, regardless of different wavelengths of light to be received by the light-receiving units. As a result, the number of types of parts in the solid-state imaging device can be reduced, enabling its manufacture to be simplified, and manufacturing costs reduced accordingly.

Further, the present invention is a solid-state imaging device including a plurality of light-receiving units two-dimensionally arrayed in a semiconductor substrate; and a filter unit that transmits incident light of wavelengths of order λ, wherein the filter unit includes a dielectric multilayer film including dielectric layers of two types, each type having a different refractive index, a distance between (i) the plurality of light-receiving units and (ii) a higher refractive index layer that is positioned closest, among the higher refractive index layers in the dielectric multilayer film, to the plurality of light-receiving units falls within a range of 1 nm and λ inclusive. According to this construction, the color filter and light-receiving elements are in contact with each other. This enables more reliable prevention of the degradation of color separation caused by oblique light.

Further, the present invention is a solid-state imaging device including a filter that transmits light of selected wavelengths of order λ, and a two-dimensional array of unit pixels, each unit pixel including: a light-receiving unit operable to detect an intensity of light; and a filter unit portion composed of a multilayer dielectric film that transmits one of red light, green light, and blue light, wherein the plurality of unit pixels are arranged in Bayer array according to a color of light transmitted by the filter unit portion, in such a manner that every square area including four adjacent unit pixels has two unit pixels that each include the filter portion that transmits blue light. As regards its transmission characteristics, a dielectric multilayer film has a smaller full width at half maximum for blue light than for red and green light. However, by employing the above arrangement, the detection bandwidth for blue light can be widened, and the sensitivity of the solid-state imaging device improved accordingly.

As described above, since the solid-state imaging device of the present invention has light shielding film formed above the wavelength selection layer, the entry of oblique light from narrow angles into adjacent pixels is inhibited.

Moreover, since a micro lens is formed in each of the apertures in the light shielding film on the substrate, the amount of oblique light entering the substrate from wide angles, which is the light most likely to enter adjacent pixels, is reduced and the amount of light concentrated on the pixel corresponding to the micro lens is increased.

The wavelength-selecting layer is a color filter, and since, with the above arrangement, light passing the light shielding film will pass exclusively into the desired color filter and subsequently enter the light receiving unit, it is possible to prevent color mixing.

Since the wavelength-selecting layer is constructed from inorganic materials, it can be formed using a process at some point during the semiconductor manufacturing process. Consequently, manufacture of the solid-state imaging device can be simplified.

Moreover, since the wavelength selecting layer is constructed from a multilayer film, the layer that selects wavelength can be made thinner and the distance between the light shielding film and the light-receiving elements reduced. Consequently, color mixing can be prevented and the amount of collected light increased.

The solid-state imaging device of the present invention includes a wavelength-selecting layer constructed from photonic crystal that selects the wavelengths of light that are to enter the corresponding light-receiving elements, which are two-dimensionally arranged in the semi-conductor substrate. As the wavelength-selecting layer is characterized by being constructed from photonic crystal, even when oblique light enters the wavelength-selecting layer of one of the pixels, light within the specified range of wavelengths is conducted vertically by the photonic crystal to the light-receiving elements, and other light is stopped. Consequently, light entering the color filter of one pixel does not enter any of the color filter sections of adjacent pixels, and color mixing can largely be prevented.

Here, the present invention includes a camera having the above-described solid-state imaging device. When a camera having the above-described characteristics is used, high quality images exhibiting very low levels of color mixing are obtained.

In the solid state imaging device manufacturing method of the present invention, in the manufacturing process to form, above the optoelectronic conversion units, the dielectric multilayer film that splits incident light according to wavelength, the method for sectionally varying the thickness of the insulation layer in order to realize the color splitting function makes use of a film forming process that effectively generates variations in the film thickness as the film is formed, rather than dry etching or wet etching to vary a thickness of a film that has already been formed. This enables better control of the film thickness, and reduction in unevenness in the film.

The above-described solid-state imaging devices have the dielectric multilayer film above the photoelectric converting unit in order to separate incident light according to wavelength. Here, the color separation can be realized by a single dielectric layer, included in the dielectric multilayer film, whose thickness varies between sections. This means that color separation can be realized using the dielectric multilayer film having a thickness substantially equivalent to the wavelength of incident light (approximately 500 nm). As a result, the color filter can be made thinner, and it is possible to significantly reduce the degradation of the color separation function caused by oblique light.

### BRIEF DESCRIPTION OF THE DRAWINGS

FIG. 1 is a cross-sectional view illustrating a construction of a solid-state imaging device;

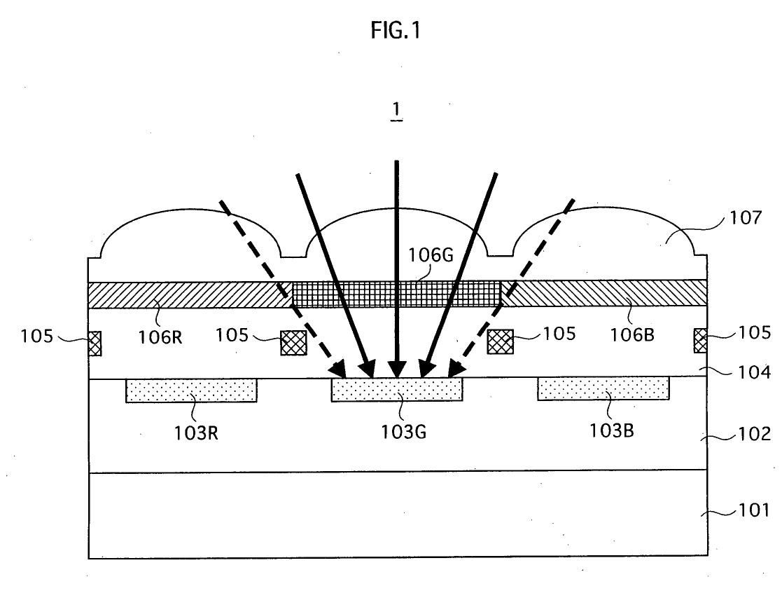

FIG. 2 is a plan view illustrating a construction of a solid-state imaging device of a first embodiment of the present invention;

FIG.3 is a cross-sectional view illustrating a construction of a solid-state imaging device of the first embodiment of the present invention;

FIG. 4 is a cross-sectional view illustrating a construction of a solid-state imaging device of a fifth embodiment of the present invention;

FIG. 5 is a cross-sectional view illustrating a manufacturing method of a color filter of the fifth embodiment of the present invention;

FIGS. 6A to 6E are cross-sectional views illustrating a manufacturing method of a color filter of a fifth embodiment of the present invention;

FIGS. 7A to 7G are cross-sectional views illustrating a manufacturing method of a color filter relating to the sixth embodiment of the present invention;

FIGS. 8A to 8F are cross-sectional views illustrating a manufacturing method of a color filter of a seventh embodiment of the present invention;

FIGS. 9A to 9F are cross-sectional views illustrating a manufacturing method of a color filter of an eighth embodiment of the present invention;

FIG. 10 is a graph illustrating transmission characteristics of the color filter relating to the fifth embodiment of the present invention;

FIG. 11 is a graph illustrating transmission characteristics observed when an optical thickness of a spacer layer in the color filter relating to the fifth embodiment of the present invention has strayed from a designed value;

FIGS. 12A to 12D are cross-sectional views illustrating a manufacturing method of a color filter of a ninth embodiment of the present invention;

FIG. 13 is a graph illustrating spectral characteristics of the color filter relating to the ninth embodiment of the present invention;

FIG. 14A and 14B show graphs illustrating dielectric multilayer films transmission characteristics which differ according to the presence or lack of a spacer layer;

FIGS. 15A to 15E are cross-sectional views illustrating a manufacturing method of a color filter of a tenth embodiment of the present invention;

FIGS. 16A to 16F are cross-sectional views illustrating a first manufacturing method of a color filter of an eleventh embodiment of the present invention;

FIGS. 17D to 17F are cross-sectional views illustrating a second manufacturing method of the color filter relating to the eleventh embodiment of the present invention;

FIGS. 18A to 18E are a cross-sectional views illustrating a manufacturing method of a color filter of a twelfth embodiment of the present invention;

FIGS. 19A to 19D are cross-sectional views illustrating a manufacturing method of a color filter of a thirteenth embodiment of the present invention;

FIGS. 20A to 20D are cross-sectional views illustrating a manufacturing method of a color filter of a fourteenth embodiment of the present invention;

FIGS. 21A to 21D are cross-sectional views illustrating a manufacturing method of a color filter of a modification example (1) of the present invention;

FIG. 22 is a graph illustrating transmission characteristics of the color filter relating to the modification example (1) of the present invention;

FIG. 23 is a cross-sectional view illustrating a construction of a color filter of a modification example (2) of the present invention;

FIG. 24 is a graph illustrating transmission characteristics of the color filter relating to the modification example (2) of the present invention;

FIG. 25 is a cross-sectional view illustrating a construction of a color filter of a modification example (3) of the present invention;

FIG. 26 is a graph illustrating transmission characteristics of the color filter relating to the modification example (3) of the present invention;

FIG. 27 is a cross-sectional view illustrating a construction of a solid-state imaging device of a modification example (4) of the present invention;

FIG. 28 is a graph illustrating transmission characteristics of a color filter relating to the modification example (4) of the present invention;

FIG. 29 is a graph illustrating transmission characteristics of a color filter of a modification example (5) of the present invention; and

FIG. 30 illustrates an arrangement of the color filter, of a modification example (6) of the present invention.

### BEST MODE FOR CARRYING OUT THE INVENTION

The following describes, with reference to the figures, a solid-state imaging device, a manufacturing method for a solid-state imaging device, and a camera, which relate the present invention.

(1) First Embodiment

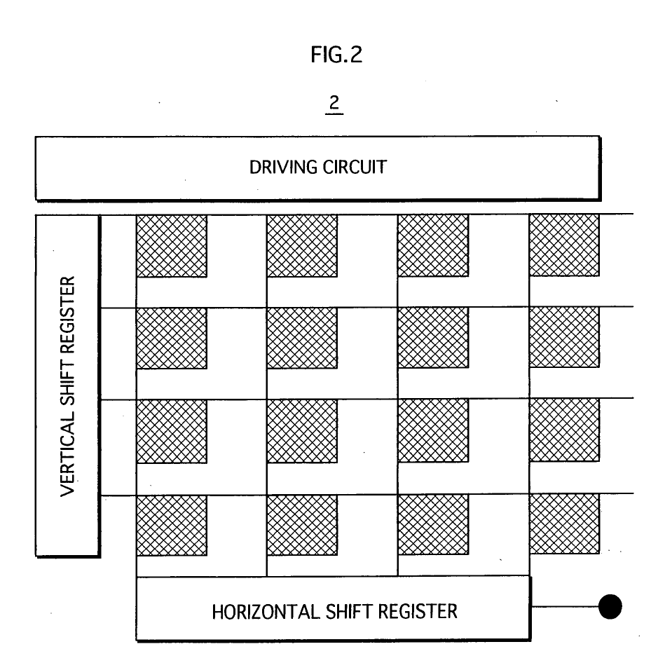

FIG. 2 is a plan view illustrating the construction of the solid-state imaging device of the first embodiment. As shown in FIG. 2, in the solid-state imaging device of the first embodiment, unit pixels (shaded parts), which are light-receiving units, are two-dimensionally arranged. A vertical shift register selects a row, and a horizontal shift register selects a signal in a pixel in the selected row. In this way, a color signal corresponding to each pixel is output through an output amplifier (not illustrated). A driving circuit causes the vertical shift register, horizontal shift register, and output amplifier to operate.

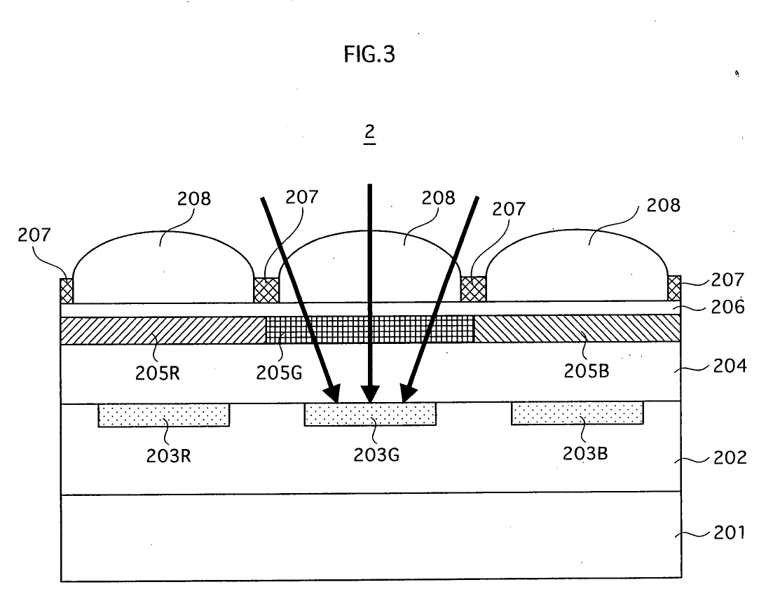

FIG. 3 is a cross -sectional view illustrating the construction of a solid-state imaging device 2 of the first embodiment of the present invention. Specifically, it shows three neighboring pixels in cross-section. As shown in FIG. 3, the solid-state imaging device 2 includes an N-type semiconductor substrate 201, a P-type semiconductor layer 202, light-receiving elements 203R, 203G, and 203B, insulation layers 204 and 206, color filter 205R, 205G and 205B, a light shielding film 207, and micro lenses 208.

The P-type semi-conductor substrate 202 is formed on the N-type semiconductor substrate 201. The light receiving elements 203R, 203G, 203B are photodiodes (photoelectric converting elements) composed of a P-type semi-conductor substrate layer infused with N-type impurities, and are in contact with the light-transmitting insulating layer 204. The light-receiving elements 203R, 203G, and 203B are separated from one another by corresponding parts of the P-type semiconductor substrate, each of which acts as a separation part between two neighboring elements. The color filter 205R, 205G and 205B is formed on the insulating layer 204.

Each section of the color filter 205R, 205G, and 205B exclusively passes R, G, or B, accordingly, where R, G, and B denote the primary colors of light. The color filter 205R, 205G, and 205B is of the type containing fine pigment particles composed of an inorganic material, and its sections are arranged in a Bayer array or complementary color mosaic.

A light-transmitting insulating layer 206 is formed on the color filter 205R, 205G, and 205B. The micro lenses 208 are disposed in one-to-one correspondence with the light-receiving elements, and are separated from one another by the light shielding film 207. Light incident upon the light shielding film is reflected. On the other hand, light incident on any of the micro lenses 208 is concentrated on the corresponding light-receiving element 203R, 203G, or 203B.

With this construction, it is possible to reduce, in comparison to conventional techniques, the distance between the color filter and the receiving element, and therefore to reduce the likelihood of oblique light entering the receiving elements. For instance, if the width of one of the receiving elements 203R, 203G, or 203B is 3 μm, it is possible to reduce color mixing by approximately 80% in comparison to conventional techniques. Further, the solid-state imaging device 2 can be entirely manufactured using semi-conductor related processes, and can therefore be manufactured simply and at low cost.

[2] Second Embodiment

The following describes the second embodiment of the present invention. The solid-state imaging device of the second embodiment largely resembles that of the first embodiment, but differs in that the color filter is composed of photonic crystals.

Photonic crystals are microstructures in which materials of differing permittivities and refraction indices, such as the semiconductor substrate and air for instance, are arranged in alternating layers, such that two contacting layers have a thickness of the order of the wavelength of light. Besides functioning as a filter that transmits only light of a specific wavelength, photonic crystals have the property of conducting incident light in a specific direction. Photonic crystals that do not transmit light of the particular range of wavelengths corresponding to the width of their band gap, namely photonic crystals having a photonic band gap are introduced in the following document:

NODA Susumu, MORIMOTO Shigeo,“Naimen hetero fotonikku kesshou ni yoru hikari nanodebaisu no jitsugen” Kagaku gijutsu shinkou danhou dai 323 go (Realizing optical nano-devices using in-plane hetero-photonic crystals, Japanese Science and Technology Corporation Journal, Issue 323).

If such photonic crystals are used as the color filter, in addition being able to selectively transmit the primary colors of light, the color filter can adjust the direction of light propagation, and therefore further prevent color mixing.

[3] Third Embodiment

The following describes the third embodiment of the present invention. The solid-state imaging device of the third embodiment largely resembles that of the second embodiment, but differs in the positioning of the shielding film.

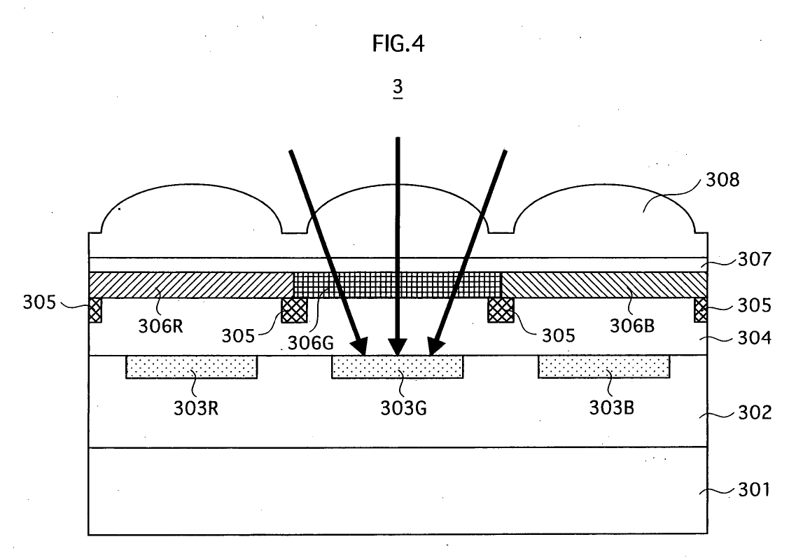

FIG. 4 is a cross-sectional view illustrating the construction of a solid-state imaging device of the third embodiment. As shown in FIG. 4, the solid-state imaging device 3 includes an N-type semiconductor substrate 301, a P-type semiconductor layer 302, light-receiving elements 303R, 303G, and 303B, insulation layers 304 and 307, a light shielding film 305, color filter 306R, 306G and 306B, and micro lenses 308.

The solid-state imaging device 3 is structured such that the P-type semiconductor substrate 302, the light-receiving elements 303R, 303G, and 303B, the light-transmitting insulating layer 304, the light shielding film 305, the color filter 306R, 306G, 306B, and the micro lenses 308 form respective layers on the N-type semiconductor substrate 301. The color filter 306R, 306G and 306B is composed of photonic crystals in the same way as the color filter of the third embodiment.

When the light shielding film is provided on the light-receiving element side of the color filter 306R, 306G, and 306B in this way, it is possible to prevent light from entering light-receiving elements other than the light-receiving elements that light whose propagation direction has been changed by the color filter 306R, 306G, or 306B would normally enter. For example, in the case where there is oblique light which enters at the edge of color filter section 306G and which could, if the light shielding film 305 were not present, enter the light-receiving element 303B, the color mixing that would otherwise occur due to the oblique light can, according to the third embodiment, be prevented.

[4] Fourth Embodiment

The following describes the fourth embodiment of the present invention. The solid-state imaging device of the fourth embodiment resembles the solid-state imaging device of the second embodiment in that it is characterized by the construction of its color filter.

The color filter of the fourth embodiment is formed by a dielectric multilayer film, in which a low refractive index material, such as silicon oxide (SiO₂), and a high refractive index material, such as silicon nitride (Si₃N₄) are alternately layered. It goes without saying that the stacking direction of the layers constituting the dielectric multilayer film matches the stacking direction of the layers constituting the solid-state imaging device 2. All but one of the layers constituting the dielectric multilayer film have substantially the same optical thickness. Here, the optical thickness of a layer is expressed as a value nd, which is the product of n denoting a refractive index of the material forming the layer, and d denoting the thickness of the layer.

According to this construction, the thickness of the color filter can be reduced, and consequently, the distance between the light-receiving elements and the light shielding film shortened. Consequently, according to the fourth embodiment, the prevention of color mixing caused by oblique light can made more reliable.

In order to improve collection efficiency of the micro lenses, it is necessary to increase their collection angle. However, even when this is done, the solid state-imaging device of the fourth embodiments can prevent color mixing. As a consequence, it is possible to improve sensitivity of the solid-state image device while continuing to prevent color mixing.

[5] Fifth Embodiment

The following describes a solid-state imaging device of a fifth embodiment of the present invention. The solid-state imaging device of the fifth embodiment has substantially the same construction as the solid-state imaging device of the fourth embodiment, but differs in the construction of the dielectric multilayer film.

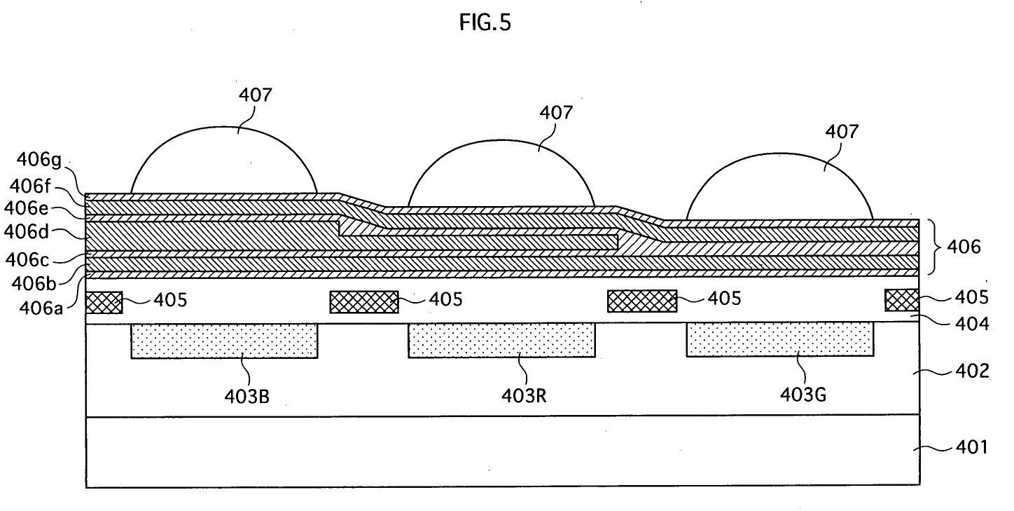

FIG. 5 is a cross -sectional view illustrating the construction of the solid-state imaging device of the fifth embodiment. As shown in FIG. 5, a solid-state imaging device 4 includes an N-type semiconductor substrate 401, a P-type semiconductor layer 402, light-receiving elements 403R, 403G, and 403B, an insulation layer 404, a light shielding film 405, a color filter 406, and micro lenses 407.

The solid-state imaging device 4 is structured such that the P-type semiconductor layer 402, light-receiving elements 403R, 403G, and 403B, light-transmitting insulation layer 404, light shielding films 405, color filter 406, and micro lenses 407 are layered in this order on the N-type semiconductor layer 401.

The color filter 406 of the fifth embodiment is characterized by being a dielectric multilayer film in which titanium dioxide (TiO₂) layers 406a, 406c, 406e and 406g, and silicon dioxide (SiO₂) layers 406b, 406d and 406f form alternate layers.

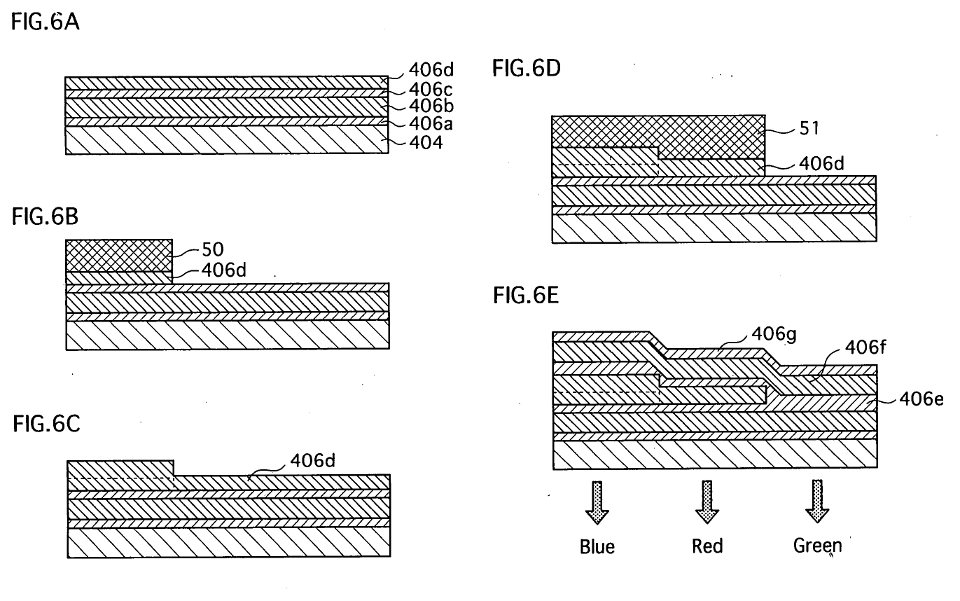

FIGS. 6A to 6E illustrate the manufacturing process of the color filter 406. Note that FIGS. 6A to 6E do not show the light shielding films 405 and light-receiving elements 403R, 403G and 403B, these being irrelevant to the manufacturing process of the color filter 406. Initially, as shown in FIG. 6A, the TiO₂ layer 406a, SiO₂ layer 406b, TiO₂ layer 406c, SiO₂ layer 406d are formed in the stated order on the insulation layer 404 using a radio frequency (RF) sputtering device.

The color filter 406 of the fifth embodiment has a λ/4 multilayer structure with a designed center wavelength λ of 530 nm. The TiO₂ layers 406a and 406c, and SiO₂ layer 406b each have an optical thickness of λ/4=132.5 nm, and the SiO₂ layer 406d has an optical thickness of 150 nm.

Next, a resist 50 is formed in a blue region on the SiO₂ layer 406d, as shown in FIG. 6B. Specifically, the resist 50 is formed by applying a resist onto the SiO₂ layer 406d, subjecting the applied resist to thermal processing (prebake), exposing it to light using an exposure device such as a stepper, developing it using a material such as an organic solvent, and once again subjecting it to thermal processing (postbake). The resist 50 has a thickness of 1 μm. Here, the blue region is a region of the color filter 406 designed to enable the light-receiving element 403B to detect blue light.

Next, the portion of the SiO₂ layer 406d not covered by the resist 50 is removed by etching. Specifically, this etching is dry etching using a CF gas, and is conducted under conditions where the etching gas is CF₄, the gas flow rate is 40 sccm, the RF is power of 200 W, and the degree of vacuum is 0.050 Torr.

Note that, instead of dry etching, wet etching with hydrofluoric acid or the like may be utilized, because the etching selectivity of SiO₂ and TiO₂ is high for hydrofluoric acid. In this case, the SiO₂ layer 406d with the resist 50 is etched by immersing the SiO₂ layer 406d and resist 50, for five seconds, in hydrofluoric acid mixed with an ammonium fluoride solution in the proportion of one to four. The SiO₂ layer 406d is thus processed into the state shown in FIG. 6B.

Subsequently, after removing the resist 50 using an organic solvent or the like, an SiO₂ layer is formed using the RF sputtering device, as shown in FIG. 6C. The new SiO₂ layer has an optical thickness of 45 nm. This means that the blue region of the SiO₂ layer 406d has an optical thickness of 195 nm, and the remaining portion of the SiO₂ layer 406d has an optical thickness of 45 nm.

Next, a resist 51 is formed in the blue region and a red region on the SiO₂ layer 406d, and a portion of the SiO₂ layer 406d not covered by the resist 51 is removed by etching, as shown in FIG. 6D. The resist 51 is then removed. Here, the red region is a region of the color filter 406 designed to enable the light-receiving element 403R to detect red light.

Subsequently, the TiO₂ layer 406e, SiO₂ layer 406f, and TiO₂ layer 406g are formed in this order across the entire RGB region using the RF sputtering device, as shown in FIG. 6E. Here, the TiO₂ layer 406e, TiO₂ layer 406g, and the SiO₂ layer 406f each have an optical thickness of λ/4.

The color filter 406 of the second embodiment can be manufactured in this way. Moreover, employing the above-described manufacturing method enables the thickness variation of each of the layers to be kept to plus/minus 2% or less, and consequently, the precision of color separation by the color filter to be improved.

[6] Sixth Embodiment

The following describes a solid-state imaging device of a sixth embodiment of the present invention. The solid-state imaging device relating to the sixth embodiment has substantially the same construction as the solid-state imaging device relating to the fifth embodiment, but differs in the manufacturing method used for the color filter. The following describes the sixth embodiment, paying particular attention to the manufacturing method for the color filter.

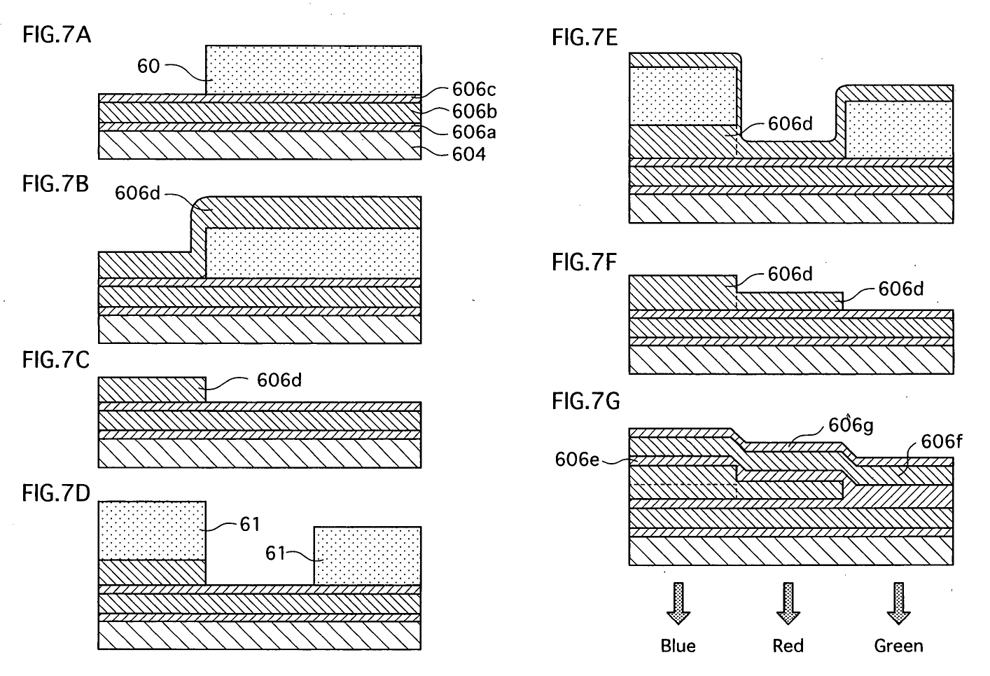

FIGS. 7A to 7G illustrates the manufacturing process for the color filter of the sixth embodiment. The light shielding film and the like are omitted from FIGS. 7A to 7G, as they were from FIGS. 6A to 6E.

Initially, a TiO₂ layer 606a, an SiO₂ layer 606b, and a TiO₂ layer 606c are formed in this order on an insulation layer 604, to form a λ/4 multilayer structure, as shown in FIG. 7A. Furthermore, a resist 60 having a thickness of 2.5 μm is formed in the red and green regions, on the TiO₂ layer 606c, as in the fifth embodiment.

Next, an SiO₂ layer 606d is formed in the blue, red, and green regions using an RF sputtering device, as shown in FIG. 7B. The SiO₂ layer 606d has an optical thickness of 195 nm.

Subsequently, the resist 60 is removed using an organic solvent or the like, as shown in FIG. 7C. This removes the portion of the SiO₂ layer that has been formed on the resist 60 (liftoff method), i.e. the red and green regions of the SiO₂ layer, leaving the blue region of the SiO₂ layer 606d.

Next, a resist 61 is formed in the blue and green regions, as shown in FIG. 7D.

Subsequently, an SiO₂ layer is formed in the blue, red and green regions, as shown in FIG. 7E. This new SiO₂ layer has an optical thickness of 45 nm.

Next, the resist 61 is removed, leaving the portion of the SiO₂ layer that has been formed on the resist 61. In other words, the blue and green regions of the SiO₂ layer are removed, leaving the red region of the SiO₂ layer, as shown in FIG. 7F.

Lastly, a TiO₂ layer 606e, an SiO₂ layer 606f, and a TiO₂ layer 606g are formed in this order across the entire RGB region, as shown in FIG. 7G.

The above description implies that it is possible to manufacture the solid-state imaging device of the fifth embodiment using the manufacturing method of the sixth embodiment, and that the manufacturing method of the sixth embodiment can produce the same effects as the manufacturing method relating to the fifth embodiment. Specifically, variation of the thickness of each of the layers forming the color filter can be kept to plus/minus 2%, enabling a solid-state imaging device to be manufactured with great precision.

[7] Seventh Embodiment

The following describes a solid-state imaging device of a seventh embodiment of the present invention. Like the sixth embodiment, the solid-state imaging device of the seventh embodiment is characterized by the manufacturing method of the color filter, and substantially resembles the solid-state imaging device of the fifth embodiment. However, the solid-state imaging device of the seventh embodiment differs from that of the fifth embodiment in the following manner. While the color filter of fifth embodiment includes an SiO₂ layer that extends across the red and blue regions, and has a different optical thickness in each of the red and blue regions, the color filter of the seventh embodiment includes an SiO₂ layer that further extends across the green region and has a different optical thickness in each of the red, green, and blue regions.

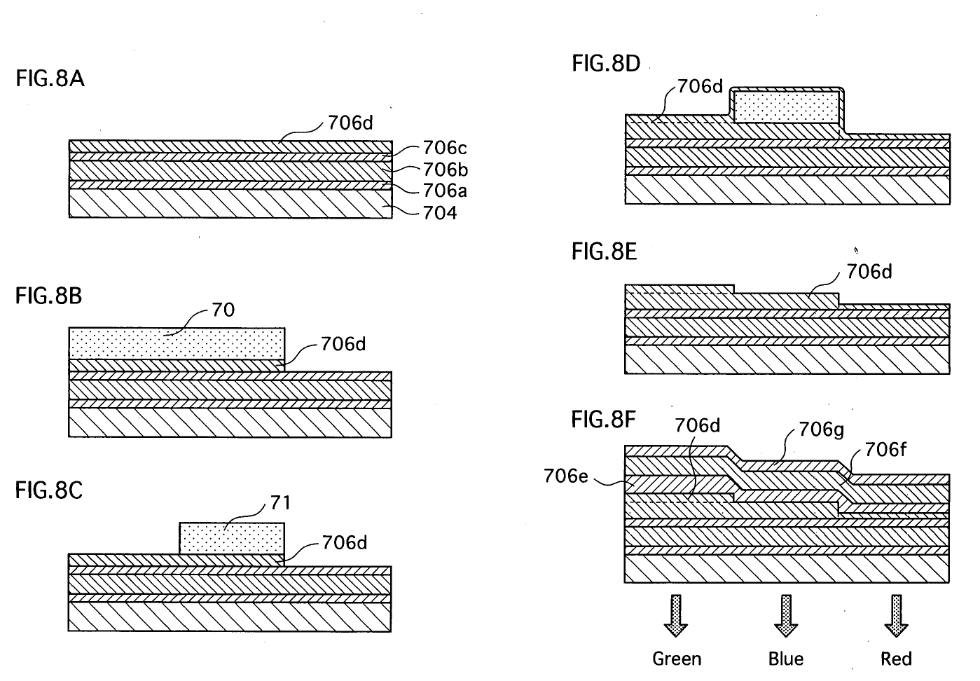

FIGS. 8A to 8F illustrate the manufacturing method of the color filter of the seventh embodiment. Initially, a TiO₂ layer 706a, an SiO2 layer 706b, a TiO₂ layer 706c, and an SiO₂ layer 706d are formed in the stated order on an insulation layer 704, as shown in FIG. 8A. The TiO₂ layers 706a and 706c, and SiO₂ layer 706b each have an optical thickness of λ/4, and the SiO₂ layer 706d has an optical thickness of 195 nm.

Next, a resist 70 is formed in the green and blue regions on the SiO₂ layer 706d. Then, the portion of the SiO₂ layer 706dcorresponding to the red region is removed by etching, as shown in FIG. 8B. This etching process may be dry etching using a CF gas, or wet etching using hydrofluoric acid.

Subsequently, the resist 70 is removed using an organic solvent or the like, and a resist 71 is formed in the blue region on the SiO₂ layer 706d, as shown in FIG. 8C.

Next, an SiO₂ layer having an optical thickness of 55 nm is formed across the entire RGB region using an RF sputtering device, as shown in FIG. 8D.

Subsequently, the resist 71 is removed using an organic solvent or the like. This removes the portion of the SiO₂ layer that has been formed on the resist 71 (liftoff method), as shown in FIG. 8E, giving the SiO₂ layer 706d an optical thickness of 250 nm in the green region, 195 nm in the blue region, and 55 nm in the red region.

Subsequently, a TiO₂ layer 706e, an SiO₂ layer 706f and a TiO₂ layer 706g are formed in this order on the SiO₂ layer 706d, and this completes the color filter of the seventh embodiment.

When an SiO₂ layer has three different levels of optical thickness, such as the SiO₂ layer 706d of the color filter of seventh embodiment, the three different sections are generally formed separately. However, in the manufacturing method of the seventh embodiment, only two layer formation steps are needed to form the SiO₂ layer 706d whose optical thickness has three levels (55 nm, 195 nm, and 250 nm). As a result, the turnaround time (TAT) can be shortened, and the manufacturing cost reduced.

[8] Eighth Embodiment

The following describes a solid-state imaging device of an eighth embodiment of the present invention. The solid-state imaging device of the eighth embodiment has substantially the same construction as the solid-state imaging device of the fifth embodiment, but differs in the construction of the color filter.

In the color filter of the solid-state imaging device of the fifth embodiment, the SiO₂ and TiO₂ layers alternate with each other. In the color filter of the solid-state imaging device of the eighth embodiment, however, a magnesium oxide (MgO) layer is additionally formed to adjust for the wavelength of light that is to be transmitted. The following describes the eighth embodiment, focusing on the manufacturing method for the color filter.

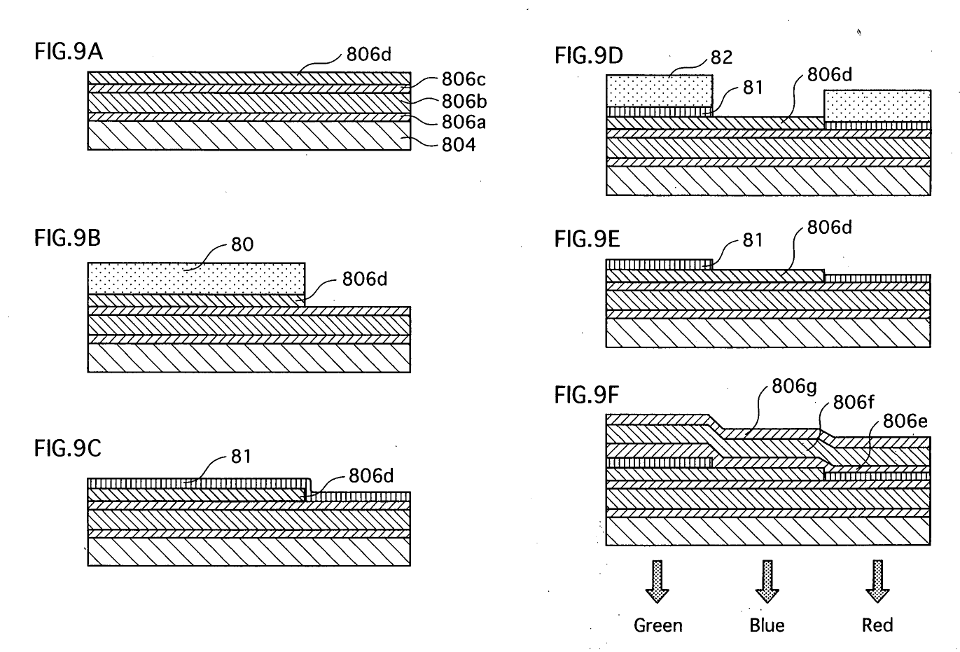

FIGS. 9A to 9F illustrate the manufacturing method of the color filter of the eighth embodiment. Initially, a TiO₂ layer 806a, an SiO₂ layer 806b, a TiO₂ layer 806c, and an SiO₂ layer 806d are formed in the stated order on an insulation layer 804, as shown in FIG. 9A. The TiO₂ layers 806a and 806c, and SiO₂ layer 806b each have an optical thickness of λ/4, and the SiO₂ layer 806d has an optical thickness of 195 nm.

Next, a resist 80 is formed on the SiO₂ layer 806d, and a portion of the resist 80 corresponding to the red region is removed. Then, the portion of the SiO₂ layer 806d corresponding to the red region is removed by etching, as shown in FIG. 9B.

Subsequently, a magnesium oxide layer 81 having an optical thickness 55 nm is formed across the entire RGB region, using an RF sputtering device, as shown in FIG. 9C.

Next, a resist 82 is formed in the green and red regions, and the portion of the MgO layer 81 corresponding to the blue region removed, as shown in FIG. 9D. Here, this portion of the MgO layer 81 can be removed in a similar way to the SiO₂ layer 706d by dry etching using a CF gas, or wet etching using hydrofluoric acid.

Subsequently, the resist 82 is removed as shown in FIG. 9E, and a TiO₂ layer 806e, an SiO₂ layer 806f, and a TiO₂ layer 806g are formed in this order as shown in FIG. 9F.

With this method, the SiO₂ layer 806d and MgO layer 81 combine to give an optical thickness of 250 nm in the green region, the SiO₂ layer 806d has an optical thickness of 195 nm in the blue region, and the MgO layer 81 has an optical thickness of 55 nm in the red region, thereby enabling and the required filter characteristics to be realized.

As described above, using two materials with etching rates that give selectivity (SiO₂ and MgO) and then performing selective etching enables an insulation layer whose thickness has three levels to be formed in only two layer-forming steps, one to form the SiO₂ layer 806d and one to form the MgO layer 81. Consequently, the TAT for the solid-state imaging device can be shortened, and the manufacturing cost reduced.

[9] Performance Evaluation

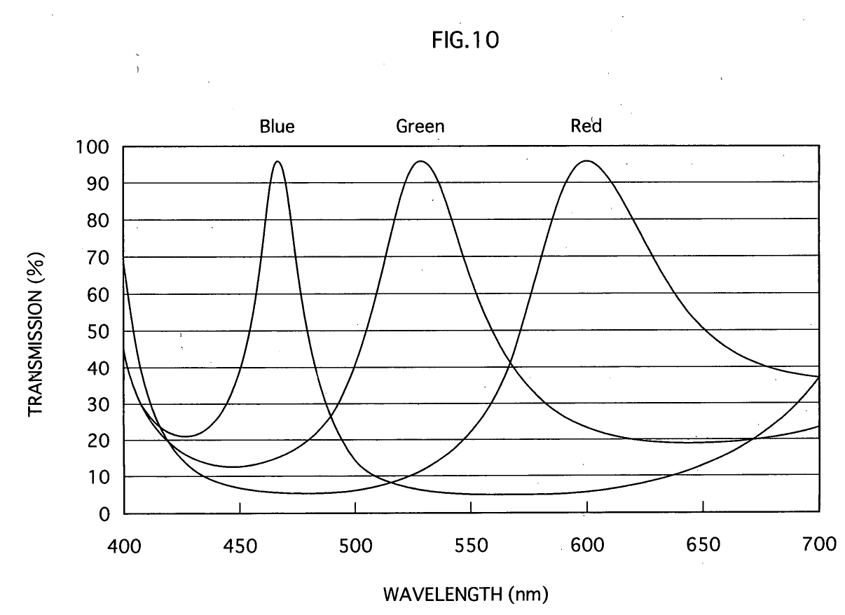

The following states the results from an evaluation of the transmission characteristics of the color filter 406 of the fifth embodiment. It should be noted that the color filter relating to the sixth embodiment has similar transmission characteristics. FIG. 10 is a graph illustrating the transmission characteristics of the color filter 406 of the fifth embodiment. As seen from FIG. 10, the color filter 406 is able to precisely separate incident light into red, green and blue. Note also that though results from their evaluation results are not stated here, the color filters relating to the fourth and fifth embodiments are also able to precisely separate incident light into red, green and blue.

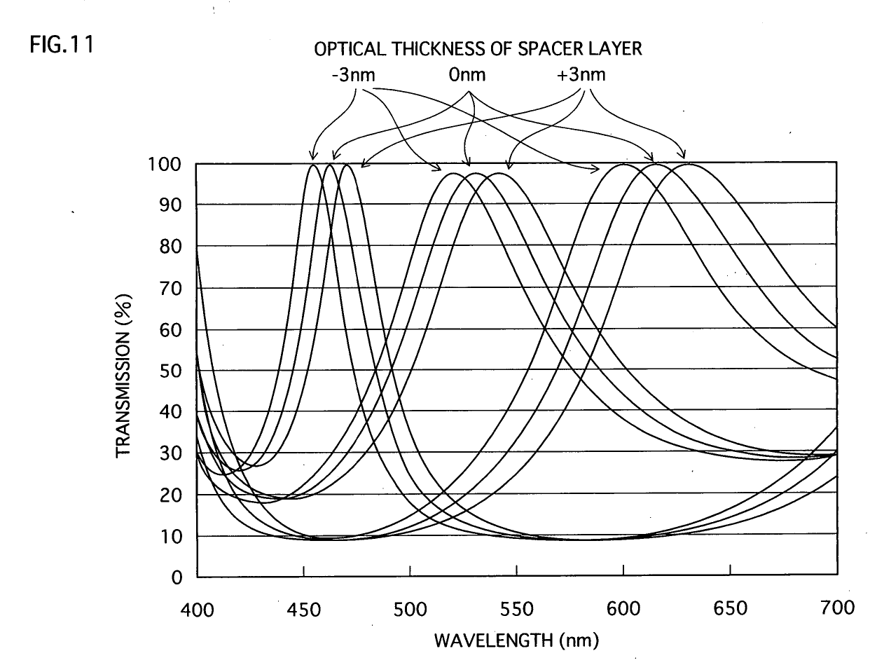

FIG. 11 is a graph illustrating the transmission characteristics observed when the optical thickness of the SiO₂ layer 406d (hereinafter, a layer which is sandwiched between layers having an optical thickness of λ/4, but which does not have an optical thickness of λ/4 is referred to as a “spacer layer”) in the color filter 406 of the fifth embodiment has strayed from a designed value. Specifically, FIG. 11 shows the cases where the optical thickness has strayed by 0 nm and plus/minus 3 nm.

As seen from FIG. 11, a difference of 3 n min the optical thickness of the space layer causes a change of approximately 10 nm in the peak emission wavelength of the transmitted light. In other words, when the thickness of the spacer layer strays from a designed value by just 3 nm, a great loss of precision occurs with respect to RGB color separation, and the solid-state imaging device is rendered impractical. For this reason, when the spacer layer is formed, its optical thickness has to be controlled precisely.

In contrast, the manufacturing methods of the above embodiments of the present invention make it possible to form the spacer layer precisely. It is consequently possible to suppress the degradation in wavelength selection properties caused by unevenness in the optical thickness of the spacer, and to prevent the loss of sensitivity and colormixing that accompany the miniaturization of solid-state imaging devices.

Conventionally, solid-state imaging devices are produced by manufacturing the light-receiving elements and the like separately from the color filter, and subsequently combining them. In the present invention, however, the color filter and the light-receiving elements and the like, are manufactured in a series of wafer fabrication processes, and it is therefore possible to improve the yield and reduce manufacturing costs.

Here, as long as the spacer layer has an appropriate optical thickness, the number of layers forming the color filter may be seven, or larger or smaller than seven. Furthermore, the numbers of layers on respective sides of the spacer layer may or may not be the same.

Moreover, the materials of the layers forming the color filter 406 are not limited to being the TiO₂, SiO₂, and MgO mentioned in the above description. Tantalum oxide (Ta₂O₅), zirconium oxide (ZrO₂), silicon nitride (SiN), silicon nitride (Si₃N₄), aluminumoxide (Al₂O₃), magnesium fluoride (MgF₂), or hafnium oxide (HfO₃) may also be used.

[10] Ninth Embodiment

The following describes a solid-state imaging device of a ninth embodiment of the present invention. While the solid-state imaging device of the ninth embodiment has a similar construction to the solid-state imaging device of the seventh embodiment, it is characterized by the manufacturing method of its color filter.

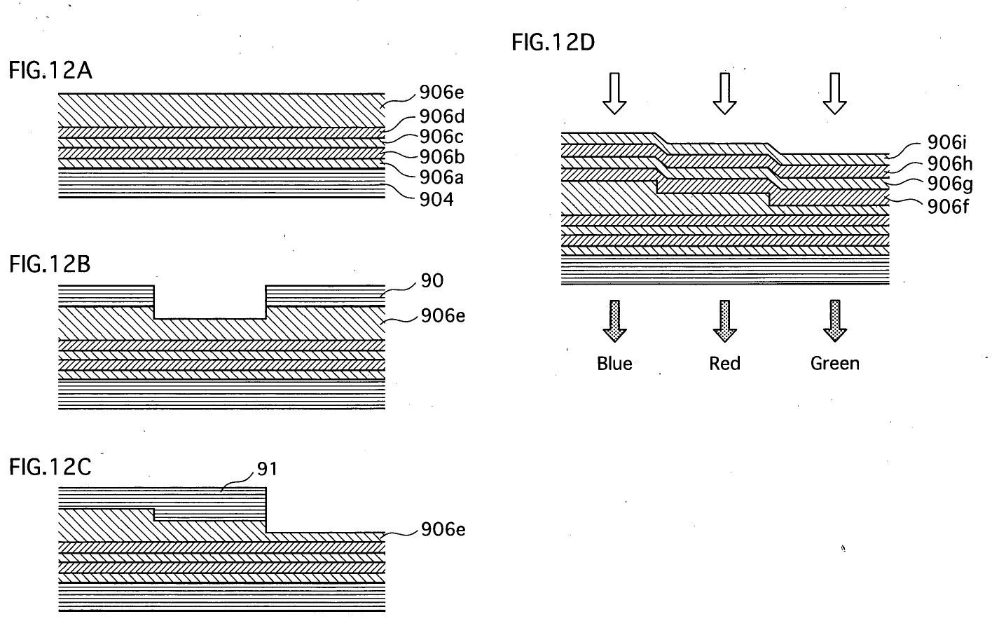

FIGS. 12A to 12D illustrate the manufacturing method of the color filter of the ninth embodiment. As shown in FIG. 12A, a TiO₂ layer 906a, an SiO₂ layer 906b, a TiO₂ layer 906c, an SiO₂ layer 906d, and a TiO₂ layer 906e are formed in the stated order on an insulation layer 904 using an RF sputtering device. The TiO₂ layers 906a and 906c, and SiO₂ layers 906b and 906d form a λ/4 multilayer structure. The TiO₂ layer 906e is a spacer layer.

Next, a resist pattern 90 is formed on the spacer layer 906e, and the red region of the spacer layer 906e is etched, as shown in FIG. 12B.

Subsequently, the resist pattern 90 is removed, a resist pattern 91 is formed, and the green region of the spacer layer 906e etched, as shown in FIG. 12C.

Next, an SiO₂ layer 906f, a TiO₂ layer 906g, an SiO₂ layer 906h, and a TiO₂ layer 906i are formed on the spacer layer 906e, as shown in FIG. 12D, there by completing the color filter. The optical thickness of the color filter is 622 nm in the blue region, 562 nm in the red region, and 542 nm in the green region.

(1) Spectral Characteristics

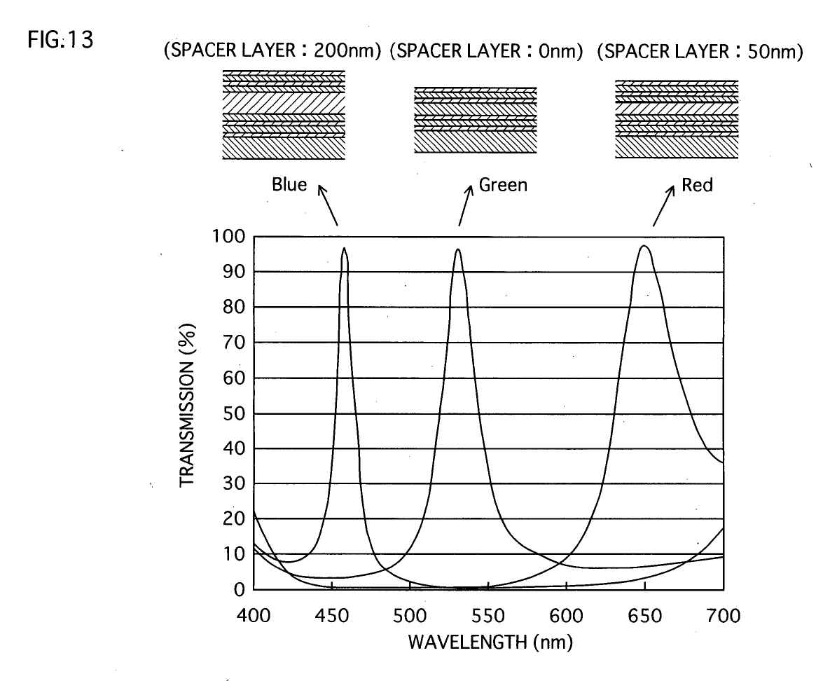

The following describes the spectral characteristics of the color filter of the ninth embodiment. FIG. 13 is a graph illustrating the spectral characteristics of the color filter of the ninth embodiment. The spectral characteristics are obtained using a characteristic matrix method, under the assumption that the refractive index of TiO₂ (the high refractive index material) is 2.5, the refractive index of SiO₂ (the low refractive index material) is 1.45, and the optical and physical thicknesses of the spacer layer are, respectively, 200 nm and 80 nm in the blue region, 50 nm and 20 nm in the red region, and 0 nm and 0 nm in the green region. Saying that the spacer layer has a physical thickness of 0 nm in the green region is equivalent to saying that the SiO₂ layers 906d and 906f, which together have an optical thickness of λ/2, serve as a spacer layer in the green region.

As seen from FIG. 13, adjusting the thickness of the spacer layer makes it possible to vary the wavelength of the light that is to be transmitted.

Note that the high refractive index material may be silicon nitride, tantalum pentoxide, zirconium dioxide or the like, instead of TiO₂ and the low refractive index material may be a material other than SiO₂.

(2) Transmission Characteristics

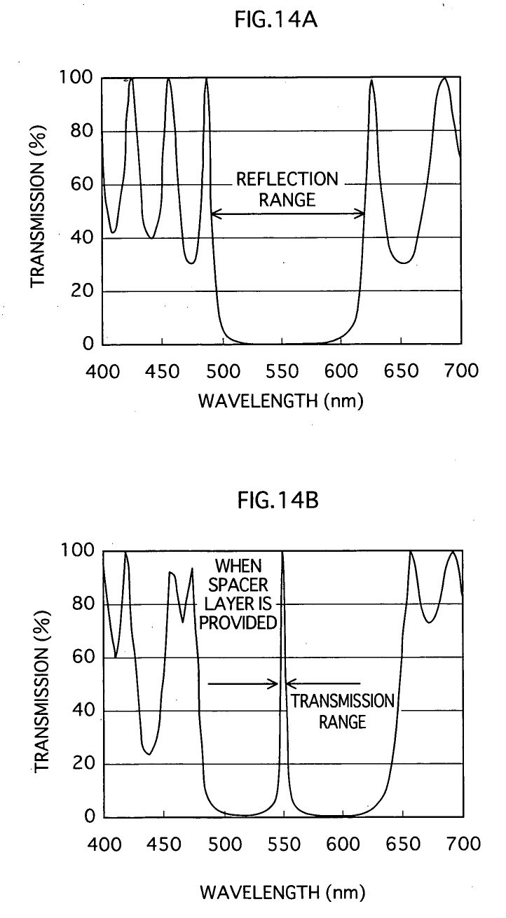

The following describes the transmission characteristics of a dielectric multilayer film. FIGS. 14A and 14B include graphs illustrating the transmission characteristics of dielectric multilayer films which differ according to the lack or presence of a spacer layer. Here, the transmission characteristics shown in FIGS. 14A and 14B are obtained using a matrix method based on a Fresnel coefficient, for vertical incident light only, under conditions where the number of pairs is ten and the designed center wavelength is 550 nm. In each of FIGS. 14A and 14B, transmittance is plotted along the vertical axis, and the wavelength of light incident on the dielectric multilayer film is plotted along the horizontal axis.

When the entire dielectric multilayer film composed of silicon nitride and silicon dioxide is a λ/4 multilayer film, the dielectric multilayer film reflects light of a wavelength band centered around the designed wavelength, as shown in FIG. 14A. Here, this reflection bandwidth widens as the difference in reflection index between the low refractive index and high refractive index materials forming the multilayer film increases.

On the other hand, when a dielectric multilayer film includes a spacer layer whose optical thickness is not λ/4, and λ/4 multilayer films symmetrically structured on the lower and upper sides of the spacer layer, it is possible to obtain a color filter which transmits the wavelengths of the λ/4 multilayer film reflection bandwidth which are in the vicinity of the designed wavelength, as shown in FIG. 12B. Moreover, if the thickness of the spacer layer is varied, the peak wavelength can be varied.

In the ninth embodiment, this property is taken into consideration, and a dielectric multilayer film used as the color filter. The thickness of the color filter can then be of the order of the wavelength of the incident light (approximately 500 nm). It is consequently possible to attain a smaller-sizedsolid-state imaging device, and effectively prevent the color mixing caused by oblique light.

Further, since, according to the ninth embodiment, the color filter can be formed together with the light receiving elements using a series of semi-conductor manufacturing processes, the quality of the solid-state imaging devices can be stabilized and the manufacturing costs reduced.

[11] Tenth Embodiment

The following describes a tenth embodiment of the present invention. A solid-state imaging device of the tenth embodiment has substantially the same construction as the solid-state imaging devices relating to the above embodiments, but differs in the construction of the spacer layer included in the color filter. In the above embodiments, the wavelength transmitted by the color filter was exclusively determined by varying the thickness of the spacer layer. In the tenth embodiment, however, the wavelength of light transmitted by the color filter is determined by forming the spacer layer using two different materials without varying the thickness. Specifically, in the tenth embodiment, the wavelength of light transmitted by the color filter is adjusted by alternately disposing two materials of differing refractive indices in a direction parallel to the main surface of the substrate.

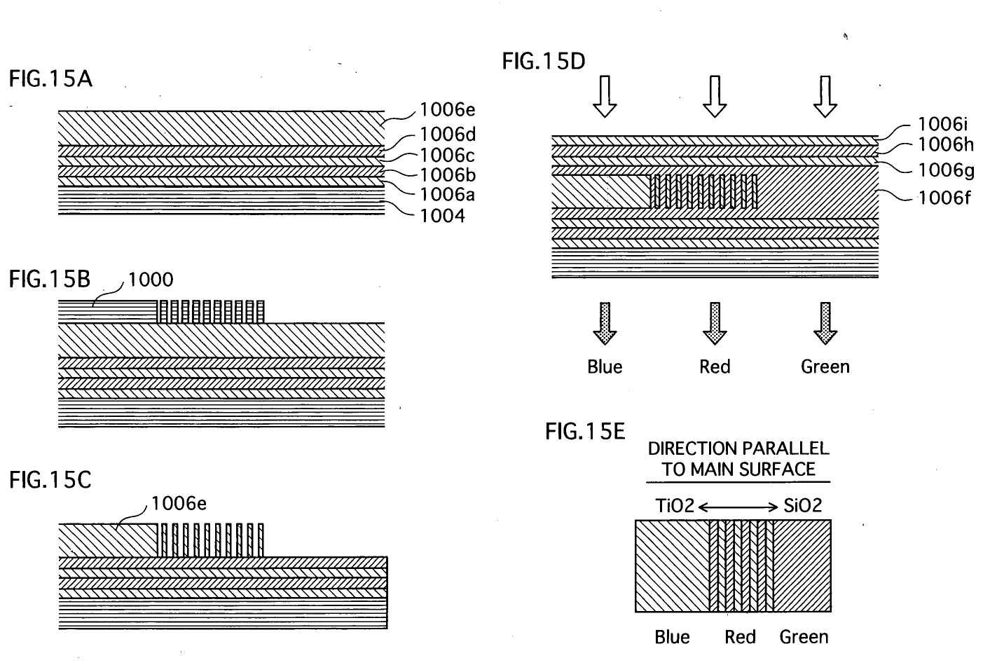

FIGS. 15A to 15E illustrate the manufacturing method of the color filter of the tenth embodiment. Initially, a TiO₂ layer 1006a, an SiO₂ layer 1006b, a TiO₂ layer 1006c, an SiO₂ layer 1006d, and a TiO₂ layer 1006e are formed on an insulation layer 1004, as shown in FIG. 15A. The TiO₂ layer 1006e is a spacer layer.

Next, a resist pattern 1000 is formed on the TiO₂ layer 1006e as shown in FIG. 15B.

Subsequently, making use of the resist pattern 1000, the TiO₂ layer 1006e is etched, and a plurality of through holes or grooves are formed in the red region of the TiO₂ layer 1006e. Here, the through holes or grooves are disposed in a direction parallel to the main surface of the TiO₂ layer 1006e. When the red region of the TiO₂ layer 1006e is seen two-dimensionally in plan view, the ratio in area between the etched region (the grooves) and the non-etched region is 4:1. Hence, the refractive index of the red region of the TiO₂ layer 1006eis defined by the following expression.
((the refractive index of SiO₂)×4/5)+((the refractive index of TiO₂)×1/5)

Here, the green region of the TiO₂ layer 1006e is completely removed by the etching process.

Next, an SiO2 layer 1006f, a TiO₂ layer 1006g, an SiO₂ layer 1006h, and a TiO₂ layer 1006i are formed in this order on the TiO₂ layer 1006e, and on the portion of the SiO₂ layer 1006d that has been exposed by the partial removal of the TiO₂ layer 1006e, and this completes color filter.

Since, with this construction, the number steps required to manufacture the solid-state imaging device can be reduced, it is possible to shorten the TAT, and reduce manufacturing costs.

[12] Eleventh Embodiment

The following describes a solid-state imaging device of an eleventh embodiment of the present invention. The solid-state imaging device of the eleventh embodiment has substantially the same construction as the solid-state imaging devices of the above embodiments, but differs in that the color filter concentrates incident light on the light-receiving elements.

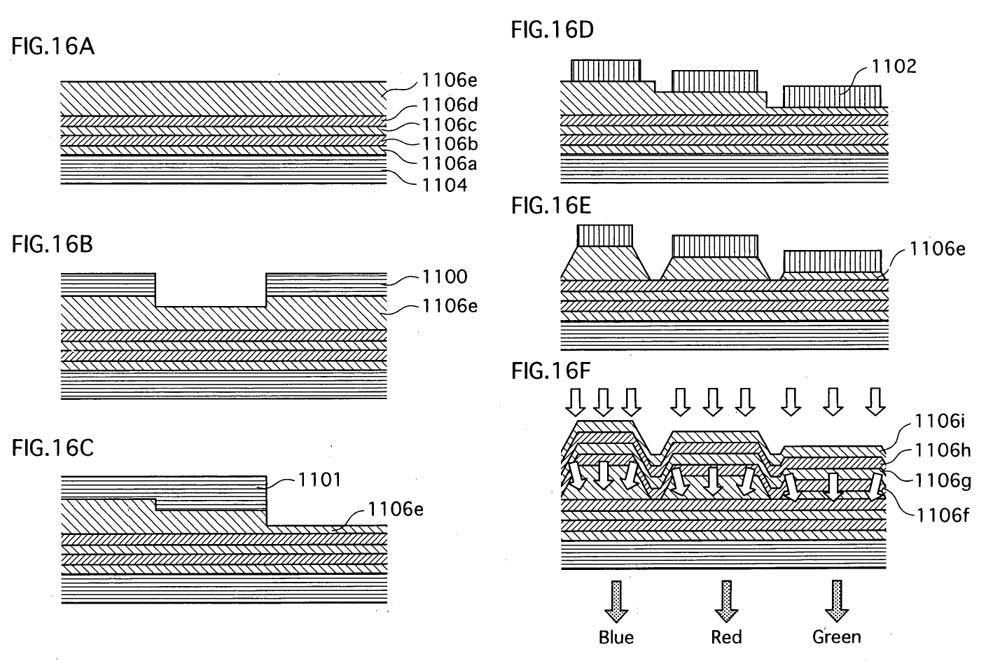

FIGS. 16A to 16F illustrate the manufacturing process of the color filter of the eleventh embodiment. Initially, a TiO₂ layer 1106a, an SiO₂ layer 1106b, a TiO₂ layer 1106c, an SiO₂ layer 1106d, and a TiO₂ layer 1106e are formed on an insulation layer 1104, as shown in FIG. 16A. Here, the TiO₂ layer 1106e is a spacer layer.

Next, a resist pattern 1100 is formed on the TiO₂ layer 1106e, and the red region of the TiO₂ layer 1106e is then etched, as shown in FIG. 16B.

Subsequently, a resist pattern 1101 is formed on the TiO₂ layer 1106e, and the green region of the TiO₂ layer 1106e etched, as shown in FIG. 16C.

Next, a resist pattern 1102 is formed on the TiO₂ layer 1106e, in the center of each of the red, green, and blue regions, as shown in FIG. 16D.

Subsequently, each of the red, green and blue regions of the TiO₂ layer 1106e is processed to have inclined lateral surfaces, using photolithography and dry etching, as shown in FIG. 16E.

Lastly, the resist pattern 1102 is removed, and an SiO₂ layer 1106f, a TiO₂ layer 1106g, an SiO₂ layer 1106h, and a TiO₂ layer 1106iare formed, thereby completing the solid-state imaging device. Here, since each of the red, green and blue regions of the TiO₂ layer 1106ehas inclined lateral surfaces as mentioned above, each of the red, green and blue regions of the lamination made up by the SiO₂ layer 1106f, the TiO₂ layer 1106g, the SiO2 layer 1106h, and the TiO₂ layer 1106i also has inclined lateral surfaces.

With such inclined lateral surfaces, light that enters the color filter through the lateral surfaces of each of the red, green and blue regions is collected towards the center of each region. Consequently, the color filter of the eleventh embodiment can more reliably prevent the degradation of color separation caused by oblique light. In addition, the color filter relating to the eleventh embodiment partially fulfills the function of the micro lens for collecting incident light. As a result, thinner micro lenses can be utilized, and a smaller-sized solid-state imaging device realized.

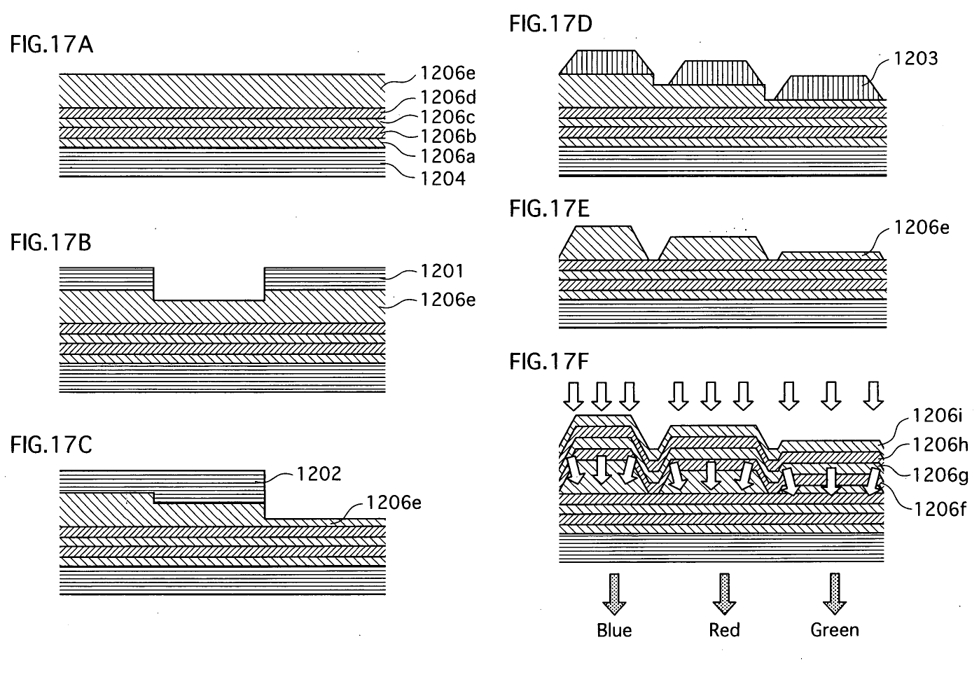

Note that the following manufacturing method can also be used to realize a color filter whose red, greenland blue regions each have inclined lateral -surfaces, and thereby obtain similar effects to those described above. FIGS. 17A to 17F illustrate this alternative manufacturing method for the color filter whose red, green, and blue regions each have inclined lateral surfaces. The steps shown in FIGS. 17A to 17C are the same as those shown in FIGS. 16A to 16C. Following these steps, a resist pattern 1203 having portions corresponding to the red, green and blue regions is formed, each portion having inclined lateral surfaces, as shown in FIG. 17D. The steps shown in FIGS. 17E and 17F are the same as those shown in FIGS. 16E and 16F. Thus, a color filter identical to the previously described color filter can also be obtained by means of this method.

Moreover, it goes without saying that using the manufacturing methods of the eleventh embodiment makes it possible attain a smaller-sized solid-state imaging device, improve the yield ratio, and reduce manufacturing costs, in the same way as manufacturing methods of the above embodiments.

[13] Twelfth Embodiment

The following describes a twelfth embodiment of the present invention. A solid-state imaging device relating to the twelfth embodiment has substantially the same construction as the solid-state imaging devices relating to the above embodiments, but differs in the shape of the spacer layer included in the color filter. In the above embodiments, the thickness of the spacer layer is uniform within each of the red, green and blue regions. The twelfth embodiment, however, is characterized by the thickness of the spacer layer varying within each region. This enables the light transmission passband to be widened.

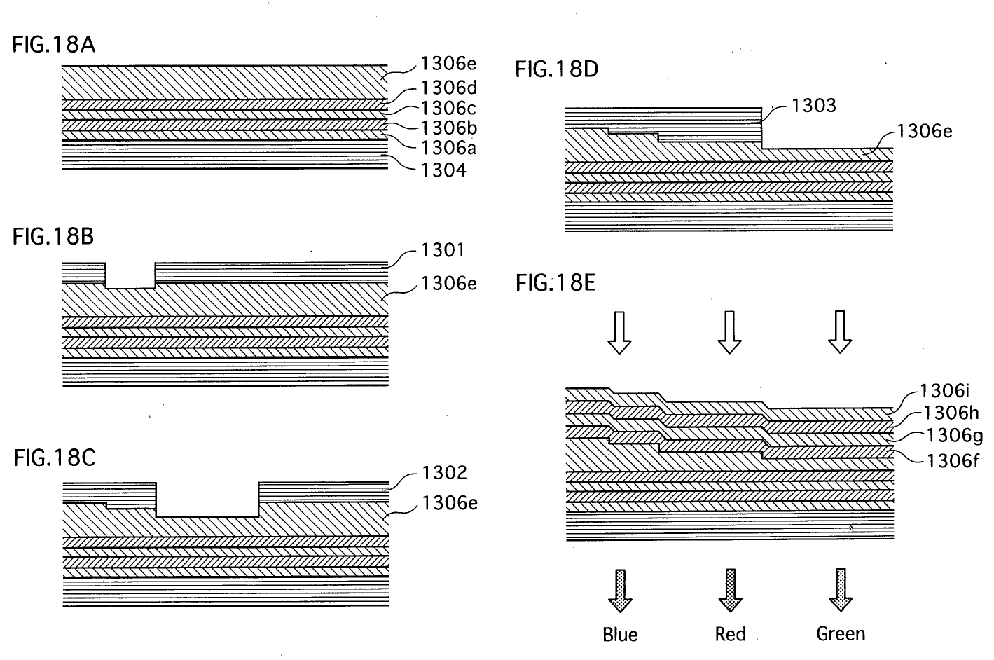

FIGS. 18A to 18E illustrate the manufacturing method of the color filter of the twelfth embodiment. In the twelfth embodiment, an etching step of removing part of the blue region of a TiO₂ layer 1306e using a resist pattern 1301 is added, as shown in FIG. 18B. Because of this additional step, the thickness of the blue region of the TiO₂ layer 1306e has two levels. This enables the passband for blue light to be widened, and the transmission characteristics of the color filter enhanced accordingly.

The thickness of the spacer layer in the blue region is not limited to having two levels, but may have three or more levels. Furthermore, variation in the thickness of the spacer layer is not limited to the blue region. The thickness of the spacer layer in the red or/and green regions layer may also be varied.

In addition, the high refractive index material may be silicon nitride, tantalumpentoxide, zirconium dioxide, or the like, instead of TiO₂, and the low refractive index material may be a material other than SiO₂.

The twelfth embodiment enables the thickness of the color filter to be kept to the order of the wavelength of incident light. Hence, the color mixing caused by oblique light can be prevented, and a smaller-sized solid-state imaging device can be realized. Furthermore, the yield can be improved, and manufacturing costs reduced.

[14] Thirteenth Embodiment

The following describes a thirteenth embodiment of the present invention. A solid-state imaging device of the thirteenth embodiment has substantially the same construction as the solid-state imaging devices of the above embodiments, but differs in that the thickness of the spacer layer varies continuously.

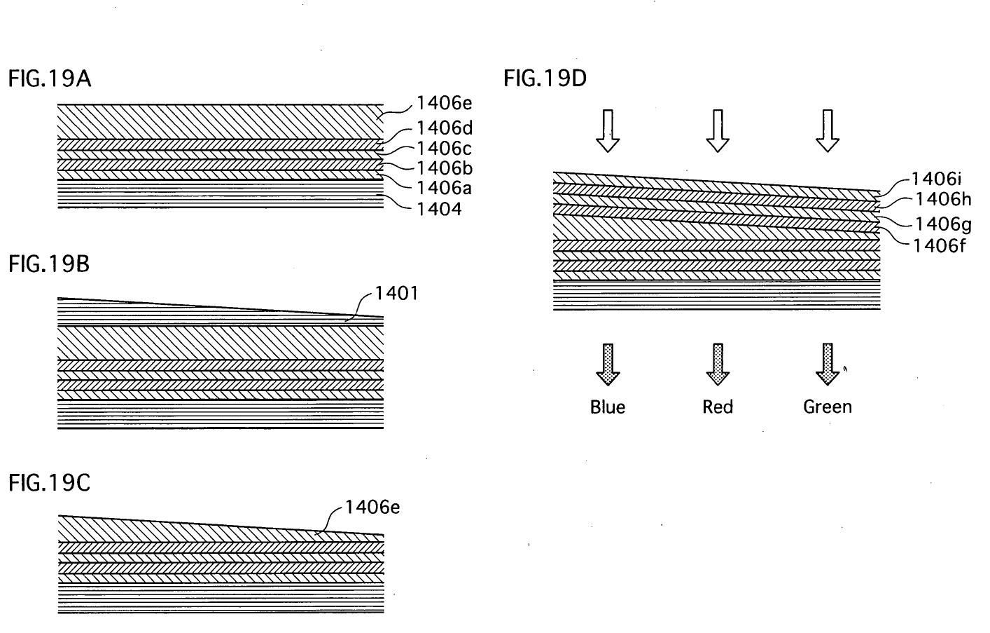

FIGS. 19A to 19D illustrate the manufacturing method of the color filter of the thirteenth embodiment. Initially, a TiO₂ layer 1406a, an SiO₂ layer 1406b, a TiO₂ layer 1406c, an SiO₂ layer 1406d, and a TiO₂ layer 1406e are formed in the stated order on an insulation layer 1404, as shown in FIG. 19A.

Next, a resist pattern 1401, whose thickness gradually reduces from the blue region, through the red region, to the green region, is formed using a photolithographic process, as shown in FIG. 19B. The photolithographic process involves continuously varying the transmittance of a chrome (Cr) film on the photomask during exposure in accordance with the desired taper, so as to gradually change the photomask light transmission characteristics.

Subsequently, the TiO₂ layer 1406e is shaped by dry etching such that its thickness gradually decreases in accordance with the taper of the resist pattern 1401, as shown in FIG. 19C.

Lastly, an SiO₂ layer 1406f, a TiO₂ layer 1406g, an SiO₂ layer 1406h, and a TiO₂ layer 1406i are formed in this order on the TiO₂ layer 1406e, as shown in FIG. 19D, thereby completing the color filter.

The passband characteristics can be further improved using this method.

[15] Fourteenth Embodiment

The following describes a fourteenth embodiment of the present invention. A solid-state imaging device of the fourteenth embodiment has substantially the same construction as the solid-state imaging devices relating to the above embodiments, but differs in that it includes an absorbing member that absorbs light reflected by the color filter.

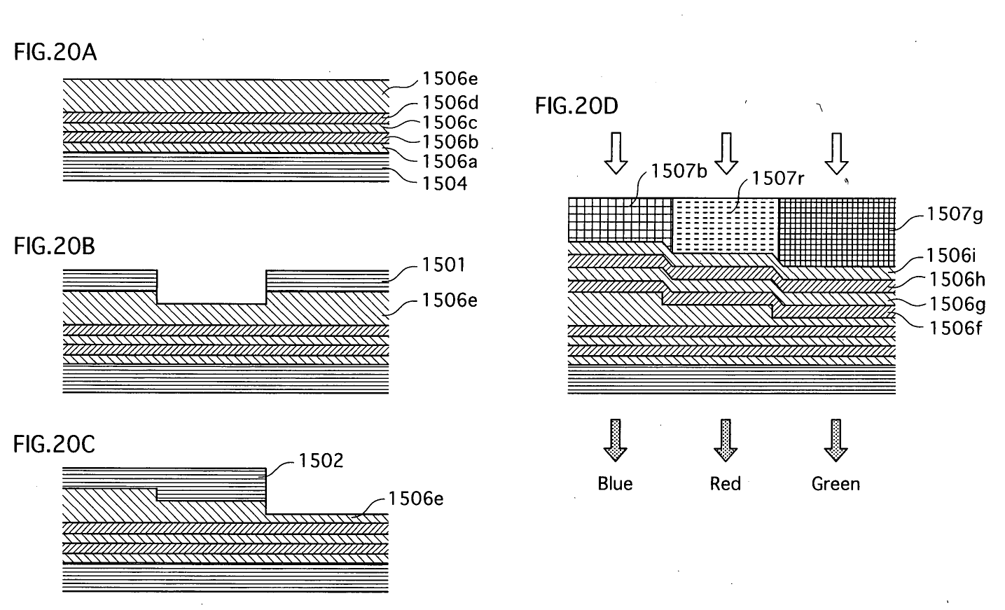

FIGS. 20A to 20D illustrate the manufacturing method of the color filter of the fourteenth embodiment. The steps shown in FIGS. 20A to 20C resemble those of the above embodiments.

As shown in FIG. 20D, the color filter relating to the fourteenth embodiment has absorbing members 1507b, 1507r, and 1507g for the respective colors, on a TiO₂ layer 1506i. The absorbing members 1507b, 1507r and 1507g may, for example, be realized using a color filter containing pigments or dyes.

As described above, a color filter that is formed from a dielectric multilayer film only transmits particular wavelengths of light, and reflects other wavelengths. This reflected light may, as a result of multiple reflections at the surface of the solid-state imaging device for instance, enter light-receiving elements other than the ones desired. This kind of problem can be solved by providing absorbing members on the color filter as in the fourteenth embodiment, since this enables noise generated by the reflected light to be suppressed.

### 16MODIFICATION EXAMPLES

Though the present invention has been described based on the above embodiments, it is not of course limited to these embodiments, and further includes the following modifications.

(1) In the above-described embodiments, the outmost layer in the color filter is always made of the high refractive index material (TiO₂). However, the present invention is not limited to such an arrangement, and the outmost layer may be made of the low refractive index material.

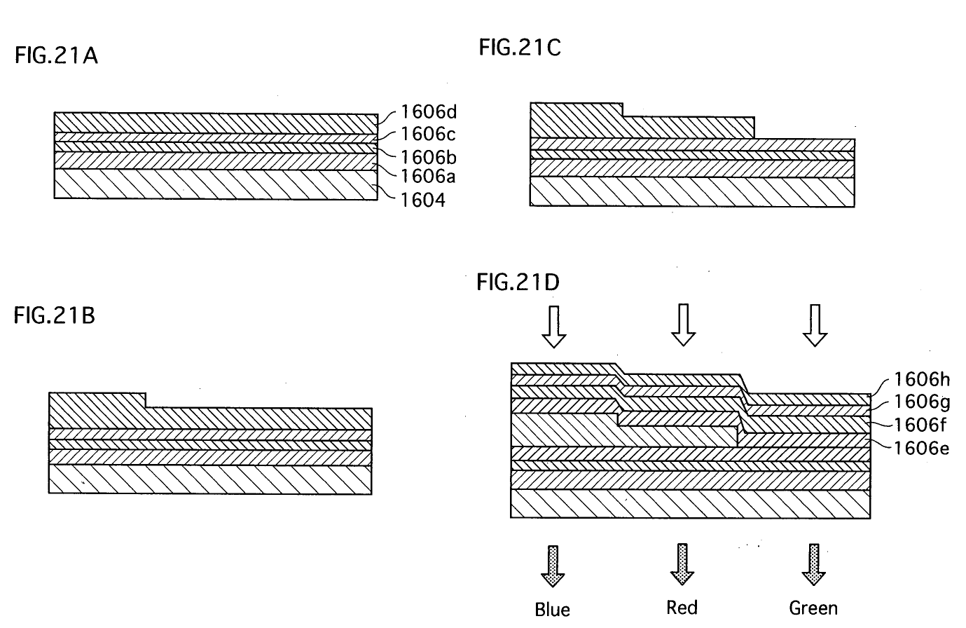

FIGS. 21A to 21D illustrate the manufacturing method of a color filter whose outmost layer is made of the low refractive index material. Initially, a TiO₂ layer 1606a, an SiO₂ layer 1606b, a TiO₂ layer 1606c, and an SiO₂ layer 1606d are formed on an insulation layer 1604, as shown in FIG. 21A.

Next, the thickness of the SiO₂ layer 1606d, which is a spacer layer, is adjusted by etching as shown in FIGS. 21B and 21C. Lastly, a TiO₂ layer 1606e, an SiO₂ layer 1606f, a TiO₂ layer 1606g, and an sio₂ layer 1606h are formed, on the SiO₂ layer 1606d and the green region of the TiO₂ layer 1606c, as shown in FIG. 21D.

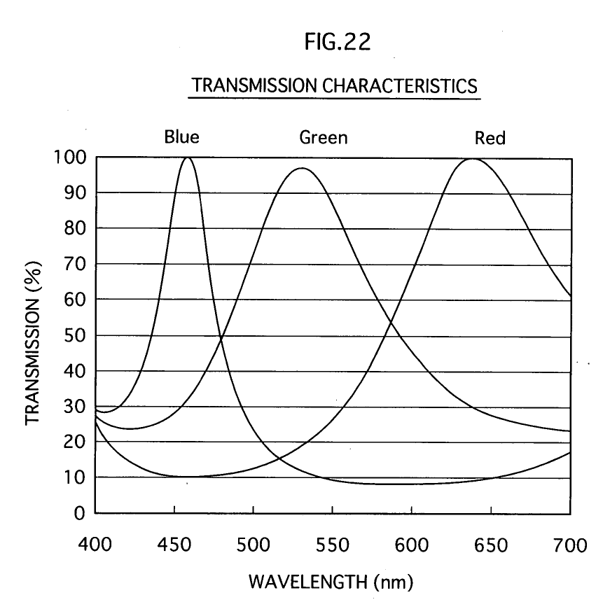

FIG. 22 is a graph illustrating the transmission characteristics of the color filter of this modification example. A comparison of FIG. 22 with FIG. 10 shows that the peak transmittance of each of blue light and red light is improved to approximately 100%, and that the peak transmittance of green light is also improved toward 100%.

With this construction, incident light is less likely to be reflected by the outmost layer in the color filter than when the high refractive index material is used. As a result, more efficient imaging can be performed. Note also that a spacer layer made of the low refractive index material is known to give better spectral sensitivity than a spacer layer made of the high refractive index material.

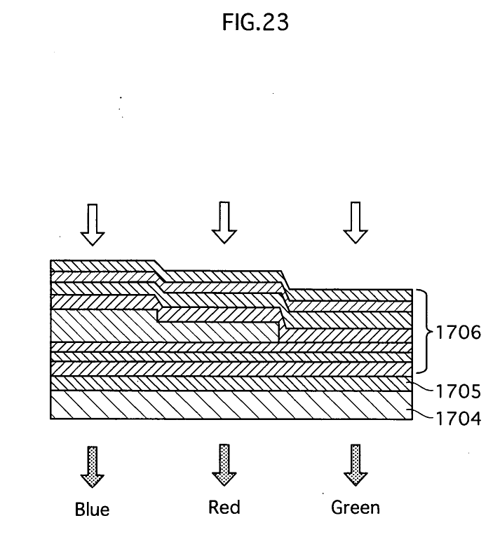

(2) The above description of the embodiments makes no particular reference to a protective layer, but one may be formed on the surface of the color filter facing the insulation layer, on the surface facing the micro lenses, or between the dielectric layers that make up the color filter. Forming a protective layer (for example, a silicon nitride layer) in such a position enables the reliability and moisture resistance of the solid-state imaging device to be improved. FIG. 23 is a cross-sectional view illustrating a color filter of this modification example. As shown in FIG. 23, a protective layer 1705, and a color filter 1706 are formed in this order on an insulation layer 1704. Here, the protective layer 1705 is made of silicon nitride.

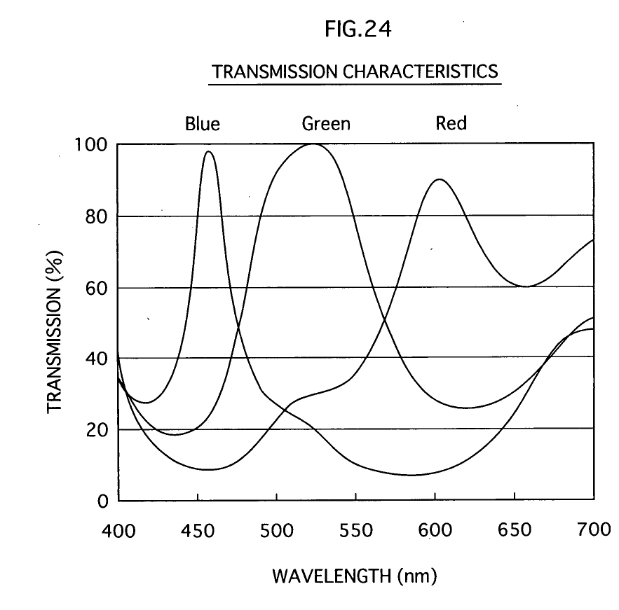

FIG. 24 is a graph illustrating the transmission characteristics of the color filter relating to this modification example. As seen from FIG. 24, the addition of the protective layer 1705 does not cause significant degradation in the transmission characteristics.

The addition of a protective layer in this way enables the reliability and moisture resistance of the solid-state imaging device to be improved.

(3) In the above description of the embodiments, the profile of the micro lens side of the color filter always resembled the profile of the spacer layer. The present invention, however is not limited to such an arrangement, and includes the following modification example.

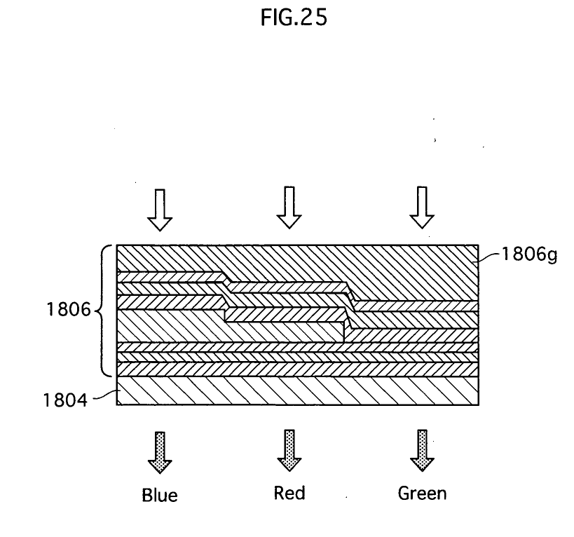

FIG. 25 shows the color filter of this modification example. As shown in FIG. 25, a color filter 1806 of this modification example has a structure in which alternating TiO₂ layers and SiO₂ layers are formed on an insulation layer 1804. In addition, an SiO₂ layer 1806g whose thickness is adjusted in accordance with the uneven surface of the color filter 1806 is formed on the surface of the color filter 1806 which faces the micro lenses, and the surface of the SiO₂ layer 1806g which faces the micro lenses is flat.

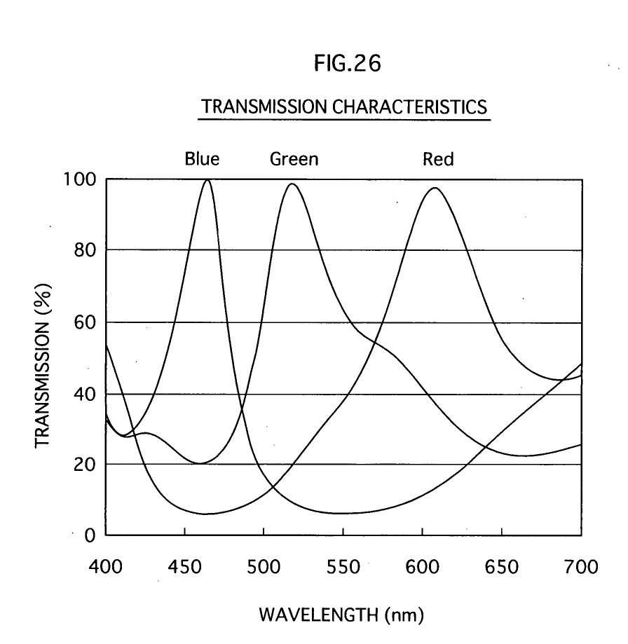

FIG. 26 is a graph illustrating the transmission characteristics of the color filter 1806. As seen from FIG. 26, the color filter 1806 has excellent transmission characteristics, despite of the presence of the SiO₂ layer 1806g.

With this construction, since the micro lenses can be easily formed, the yield can be improved, and manufacturing costs reduced. Furthermore, there is no need to use micro lenses having a different focal length for each color.

(4) In the above description of the embodiments, the color filter is always formed on the insulation layer. However, the present invention is not limited to such an arrangement, and includes the following modification example.

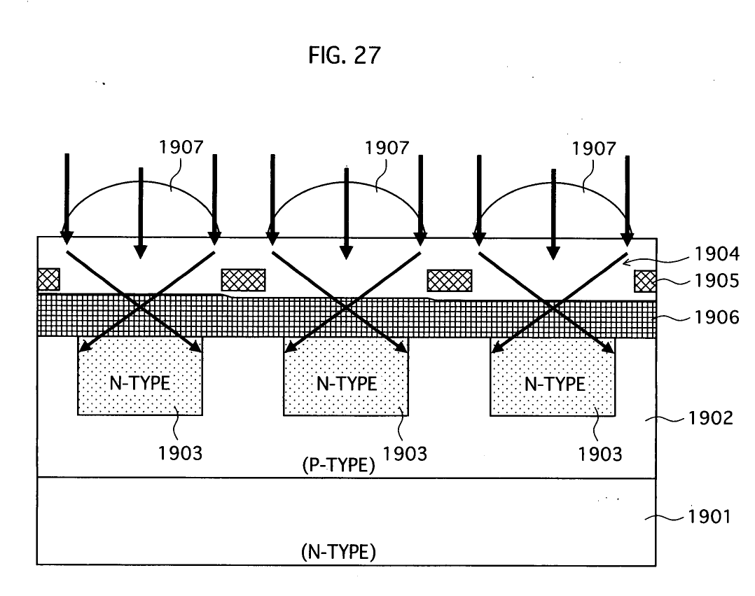

The color filter may be formed so as to be in contact with the light-receiving elements. FIG. 27 is a cross-sectional view illustrating a construction of a solid-state imaging device of this modification example.

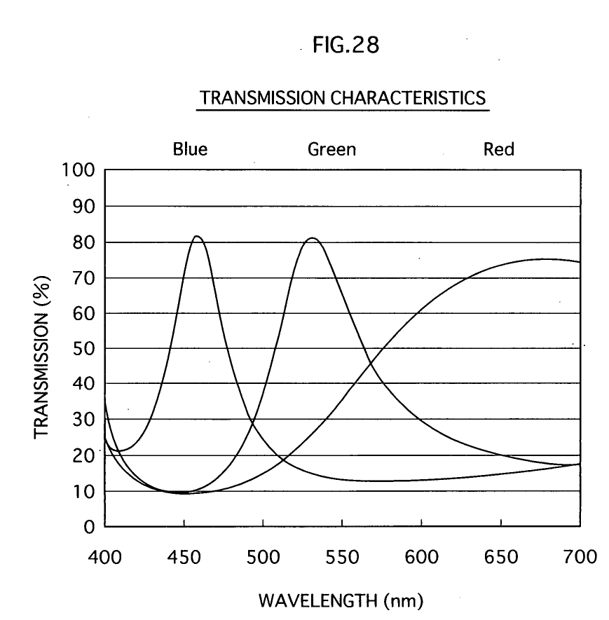

As shown in FIG. 27, the solid-state imaging device of this modification example includes an N-type semiconductor substrate 1901, a P-type semiconductor layer 1902, light-receiving elements 1903, a color filter 1906, an insulation layer 1904, a light shielding film 1905, and micro lenses 1907. FIG. 28 is a graph illustrating the transmission characteristics of the color filter 1906. FIG. 28 confirms that the construction of this modification causes no particular degradation in the transmission characteristics of the color filter 1906.

With this construction, since the color filter is formed so as to be in contact with the light-receiving elements, color mixing due to oblique light can be prevented more reliably.

Here, the distance from the surface of the semiconductor to the high refractive index layer in the color filter should be at least 1 nm, but no more than the wavelength of the light transmitted by the color filter. Between the surface of the semiconductor and the high refractive index layer in the color filter, a low refractive index layer, which is part of the color filter, or a buffer layer may be provided. For example, when the high refractive index layer is a TiO₂ layer and the low refractive index layer is an SiO₂ layer, the distance from the TiO₂ layer to the light-receiving elements (the surface of the semiconductor) will preferably fall within the above range. In other words, it is desirable that the optical thickness of the SiO₂ layer in contact with the light-receiving elements at least 1 nm but no more than the wavelength of light transmitted by the color filter.

(5) According to the above description of the embodiments, in a color filter having alternating TiO₂ and SiO₂ layers, a color filter can be obtained whichever of the TiO₂ and SiO₂ layers is used as the spacer layer.

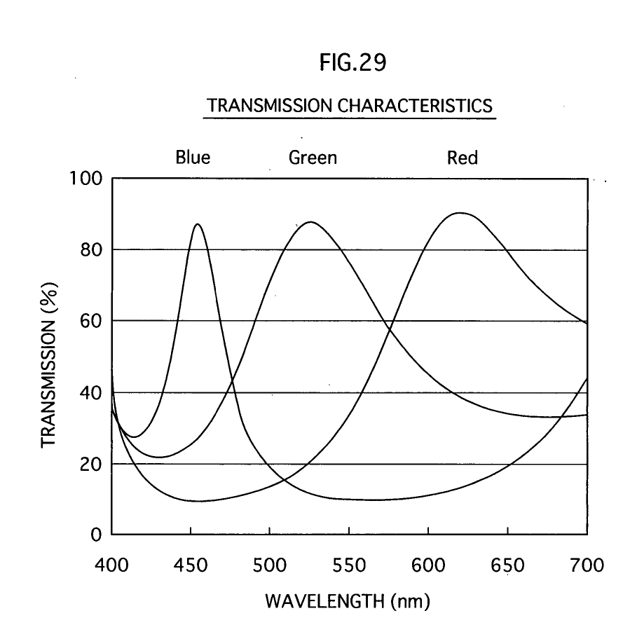

However, from the point of view of transmittance, it is preferable that the spacer layer is an SiO₂ layer. FIG. 29 is a graph illustrating the transmission characteristics of the color filter whose spacer layer is a TiO₂ layer. As seen from FIG. 29, when the spacer layer is a TiO₂ layer, none of the peak transmittances for blue, green, and red reaches 90%.

When the spacer layer is an SiO₂ layer, on the other hand, the peak transmittance of each of blue, green, and red is 95% or higher, as seen from FIG. 10 for example. Consequently, in color filters having alternating SiO₂ and TiO₂ layers, the spacer layer is preferably an SiO₂ layer.

Here, the optical thickness of the spacer layer is preferably at least 1 nm but no more than a wavelength of light transmitted by the filter. An optical thickness within this range both lowers the reflectance of the spacer layer and enables the spacer layer to act as a buffer layer between the silicon substrate and the TiO₂ layer.

(6) The above description of the embodiments states simply that red, green and blue regions of the color filter are arranged in Bayer array. The following specifically describes a desirable arrangement of red, green, and blue regions of the color filter.

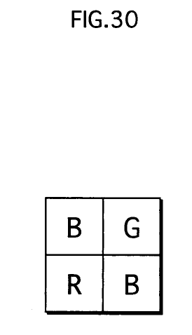

FIG. 30 illustrates an arrangement of red, green and blue regions of the color filter of this modification example, showing a minimum unit (four pixels) of the Bayer array. All the pixels are arranged in this minimum unit which is repeated. As seen from FIG. 30, two pixels out of the four pixels forming the minimum unit of the Bayer array detect blue light, and the remaining two pixels detect red light and green light respectively.

Due to its its transmission characteristics, the color filter has a smaller full width at half maximum for blue light than for red or green light. By employing the above arrangement, however, the passband for detecting blue light can be widened, and the sensitivity of the solid-state imaging device improved.

(7) According to the above description of the tenth embodiment, the grooves are formed in the red region of the TiO₂ layer, and filled with SiO₂. However, the present invention is not limited to such an arrangement, and includes the following modification example. For instance, depressions may be provided in the TiO₂ layer in place of the grooves, and filled with SiO₂. In this case too, the refractive index of this region of the TiO₂ layer can be defined by the expression shown in the tenth embodiment. Alternatively, the grooves may be provided concentrically.

### INDUSTRIAL APPLICABILITY

The solid-state imaging device, the manufacturing method of the solid-state imaging device, and a camera using the same, which are all of the present invention, are applicable as technologies to achieve a color solid-state imaging device having a smaller size and improved performance.

1. A solid-state imaging device comprising:
a plurality of light-receiving units two-dimensionally arrayed in a semiconductor substrate;
a filter unit operable to transmit incident light of selected wavelengths to the plurality of light receiving units; and
a light shielding unit operable to shield incident light, the light shielding unit having a plurality of apertures, each aperture opposing a corresponding light receiving unit, wherein
on a path of incident light from the light shielding unit to the plurality of light-receiving units, the filter unit is disposed between the light shielding unit and the plurality of light-receiving units, and
the filter unit is composed of an inorganic material.

2. The solid-state imaging device of claim 1, further comprising
a condensing unit operable to condense incident light on the corresponding light-receiving unit disposed in each of the plurality of apertures in the shielding unit.

3. The solid-state imaging device of claim 2, wherein
except for at the plurality of apertures, the light shielding unit reflects the incident light.

4. The solid-state imaging device of claim 2, wherein
the filter unit has a multilayer film structure.

5. The solid-state imaging device of claim 2, wherein
the filter unit is composed of photonic crystal.

6. A solid-state imaging device comprising:
a plurality of light-receiving units two-dimensionally arrayed in a semiconductor substrate; and
a filter unit operable to transmit light of selected wavelengths to the plurality of light receiving units, wherein
the filter unit is composed of photonic crystal having a microstructure of alternately layered materials that differ in refractive index and/or permittivity, a thickness of any given two contacting layers in the microstructure being of the order of a wavelength of light.

7. A camera comprising a solid-state imaging device including:
a plurality of light-receiving units two-dimensionally arrayed in a semiconductor substrate;
a filter unit operable to transmit incident light of selected wavelengths to the plurality of light receiving units; and
a light shielding unit operable to shield incident light, the light shielding unit having a plurality of apertures, each aperture opposing a corresponding light receiving unit, wherein
on a path of incident light from the light shielding unit to the plurality of light-receiving units, the filter unit is disposed between the light shielding unit and the plurality of light-receiving units.

8. A camera comprising a solid-state imaging device including:
a plurality of light-receiving units two-dimensionally arrayed in a semiconductor substrate; and
a filter unit operable to transmit light of selected wavelengths to the plurality of light receiving units, wherein
the filter unit is composed of photonic crystal.

9-32. (canceled)
